(19) United States
(12) Patent Application Publication
(10) Pub. No.: US 2025/0389840 A1
(43) Pub. Date: Dec. 25, 2025

(54) METHOD AND APPARATUS FOR DEVICE DISCOVERY AND SYNCHRONIZATION IN ULTRA WIDE BAND COMMUNICATION

(71) Applicant: Samsung Electronics Co., Ltd., Suwon-si (KR)

(72) Inventors: Joohyun LEE, Suwon-si (KR); Jinwook SEO, Suwon-si (KR); Junyoung CHOI, Suwon-si (KR)

(21) Appl. No.: 19/239,271

(22) Filed: Jun. 16, 2025

(30) Foreign Application Priority Data
Jun. 20, 2024 (KR) 10-2024-0080571

(51) Int. Cl. G01S 13/76; G01S 13/02; H04W 4/80; H04W 56/00

(52) U.S. Cl. CPC G01S 13/765; G01S 13/0209; H04W 4/80; H04W 56/002

(57) ABSTRACT

A method performed by a first electronic device using ultra-wide band (UWB) communication is provided. The method includes establishing a UWB session based on information related to the UWB session, broadcasting a control message using the UWB session, and performing communication with a second electronic device and a third electronic device based on the control message, wherein the UWB session of a first ranging interval includes a hybrid UWB (HUS) session including at least one contention-based ranging (CBR) phase and at least one first two-way ranging (TWR) phase, and a second TWR session.

### CROSS-REFERENCE TO RELATED APPLICATION(S)

This application is based on and claims priority under 35 U.S.C. § 119(a) of a Korean patent application number 10-2024-0080571, filed on Jun. 20, 2024, in the Korean Intellectual Property Office, the disclosure of which is incorporated by reference herein in its entirety.

### BACKGROUND

### 1. Technical Field

The disclosure relates to ultra wide band (UWB) communication. More particularly, the disclosure relates to a method and device for providing device discovery and synchronization in UWB communication.

### 2. Description of Related Art

In order to meet the demand for wireless data traffic soaring since the fourth generation (4G) communication system came to the market, there are ongoing efforts to develop enhanced fifth generation (5G) communication systems or pre-5G communication systems. For the reasons, the 5G communication system or pre-5G communication system is called the beyond 4G network communication system or post long term evolution (LTE) system.

For higher data transmit rates, 5G communication systems are considered to be implemented on ultra-high frequency bands (millimeter wave (mmWave)), such as, e.g., 60 gigahertz (GHz). To mitigate pathloss on the ultra-high frequency band and increase the reach of radio waves, the following techniques are taken into account for the 5G communication system beamforming, massive multi-input multi-output (MIMO), full dimensional MIMO (FD-MIMO), array antenna, analog beamforming, and large scale antenna.

Also being developed are various technologies for the 5G communication system to have an enhanced network, such as evolved or advanced small cell, cloud radio access network (cloud RAN), ultra-dense network, device-to-device (D2D) communication, wireless backhaul, moving network, cooperative communication, coordinated multi-point (COMP), and interference cancellation.

There are also other various schemes under development for the 5G system including, e.g., hybrid frequency shift keying (FSK) and quadrature amplitude modulation (QAM) (FQAM) and sliding window superposition coding (SWSC), which are advanced coding modulation (ACM) schemes, and filter bank multi-carrier (FBMC), non-orthogonal multiple access (NOMA) and sparse code multiple access (SCMA), which are advanced access schemes.

Meanwhile, the Internet is evolving from the human-centered connection network by which humans create and consume information to the Internet of Things (IoT) network by which information is communicated and processed between things or other distributed components. The Internet of Everything (IoE) technology may be an example of a combination of the Big data processing technology and the IoT technology through, e.g., a connection with a cloud server.

To implement the IoT, technology elements, such as a sensing technology, wired/wireless communication and network infra, service interface technology, and a security technology, are required. There is a recent ongoing research for inter-object connection technologies, such as the sensor network, Machine-to-Machine (M2M), or the Machine-Type Communication (MTC).

In the IoT environment may be offered intelligent Internet Technology (IT) services that collect and analyze the data generated by the things connected with one another to create human life a new value. The IoT may have various applications, such as the smart home, smart building, smart city, smart car or connected car, smart grid, health-care, or smart appliance industry, or state-of-art medical services, through conversion or integration of existing IT technologies and various industries.

Thus, there are various ongoing efforts to apply the 5G communication system to the IoT network. For example, the sensor network, machine-to-machine (M2M), machine type communication (MTC), or other 5G techniques are implemented by schemes, such as beamforming, multi-input multi-output (MIMO), and array antenna schemes. The above-mentioned application of the cloud radio access network as a Big data processing technique may be said to be an example of the convergence of the 5G and IoT technologies.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device for device discovery and synchronization in a multi-host case in UWB communication.

Another aspect of the disclosure is to provide a session configuration in a multi-host case in UWB communication.

Additional aspects will be set forth in part in the description which follows and, in part, will be apparent from the description, or may be learned by practice of the presented embodiments.

In accordance with an aspect of the disclosure, a method by a first electronic device using ultra-wide band (UWB) communication is provided. The method includes establishing a UWB session based on information related to the UWB session, broadcasting a control message using the UWB session, and performing communication with a second electronic device and a third electronic device based on the control message, wherein the UWB session of a first ranging interval includes a hybrid UWB (HUS) session including at least one contention-based ranging (CBR) phase and at least one first two-way ranging (TWR) phase and a second TWR session.

In accordance with another aspect of the disclosure, a method by a second electronic device using ultra-wide band (UWB) communication is provided. The method includes establishing a UWB session based on information related to the UWB session, receiving, from a first electronic device, a control message using the UWB session, and performing communication with the first electronic device and a third electronic device based on the control message, wherein the UWB session of a first ranging interval includes a hybrid UWB (HUS) session including at least one contention-based ranging (CBR) phase and at least one first two-way ranging (TWR) phase and a second TWR session.

In accordance with another aspect of the disclosure, a method by a third electronic device using ultra-wide band (UWB) communication is provided. The method by a third electronic device using UWB communication includes receiving information related to a UWB session, establishing the UWB session based on the UWB session-related information, receiving a control message from a first electronic device using the UWB session, and performing communication with at least one of the first electronic device or the second electronic device based on the control message. The second electronic device is synchronized with the first electronic device. The UWB session of a first ranging interval includes a hybrid UWB (HUS) session including at least one contention-based ranging (CBR) phase and at least one first two-way ranging (TWR) phase and a second TWR session.

In accordance with another aspect of the disclosure, a first electronic device using ultra-wide band (UWB) communication is provided. The first electronic device includes a transceiver and at least one processor, wherein the at least one processor is configured to establish a UWB session based on information related to the UWB session, broadcast a control message using the UWB session, and perform communication with a second electronic device and a third electronic device based on the control message, and wherein the UWB session of a first ranging interval includes a hybrid UWB (HUS) session including at least one contention-based ranging (CBR) phase and at least one first two-way ranging (TWR) phase and a second TWR session.

In accordance with another aspect of the disclosure, a second electronic device using ultra-wide band (UWB) communication is provided. The second electronic device includes a transceiver, and at least one processor, wherein the at least one processor is configured to establish a UWB session based on information related to the UWB session, receive, from a first electronic device, a control message using the UWB session, and perform communication with the first electronic device and a third electronic device based on the control message, wherein the UWB session of a first ranging interval includes a hybrid UWB (HUS) session including at least one contention-based ranging (CBR) phase and at least one first two-way ranging (TWR) phase, and a second TWR session.

In accordance with another aspect of the disclosure, a third electronic device using ultra-wide band (UWB) communication is provided. The third electronic device using UWB communication includes a transceiver and at least one processor. The at least one processor is configured to receive information related to a UWB session, establish a UWB session based on the UWB session-related information, receive a control message from a first electronic device using the UWB session, and perform communication with at least one of the first electronic device or the second electronic device based on the control message, wherein the second electronic device is synchronized with the first electronic device. The UWB session of a first ranging interval includes a hybrid UWB (HUS) session including at least one contention-based ranging (CBR) phase and at least one first two-way ranging (TWR) phase and a second TWR session.

Efficient communication in a payment system is possible using a session configuration in a multi-host case in UWB communication of the disclosure.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example architecture of an electronic device according to an embodiment of the disclosure;

FIG. 2 illustrates a communication system including a plurality of electronic devices according to an embodiment of the disclosure;

FIG. 3 illustrates a payment system using UWB according to an embodiment of the disclosure;

FIG. 4 illustrates a method for providing a UWB-related service according to an embodiment of the disclosure;

FIG. 5 is a view illustrating a multi-POS scenario in a UWB payment system according to an embodiment of the disclosure;

FIGS. 6A, 6B, 6C, 6D, 6E, and 6F are views illustrating a configuration of a session for each process of UWB communication according to various embodiments of the disclosure;

FIGS. 7A and 7B are views illustrating a multi-host scenario in a payment system using UWB communication according to various embodiments of the disclosure;

FIGS. 8A and 8B are views illustrating an example of a session configuration in a multi-host case in a UWB payment system according to various embodiments of the disclosure;

FIGS. 9A and 9B are views illustrating an example of operations of a first host terminal and a second host terminal in a session configuration in a multi-host case in a UWB payment system according to various embodiments of the disclosure;

FIGS. 10A and 10B are views illustrating an example of a time synchronization operation in a session configuration in a multi-host case in a UWB payment system according to various embodiments of the disclosure;

FIG. 11 is a view illustrating an example of a time synchronization operation in a session configuration in a multi-host case in a UWB payment system according to an embodiment of the disclosure;

FIGS. 12A, 12B, and 12C are views illustrating an example of a time synchronization operation in a session configuration in a multi-host case in a UWB payment system according to various embodiments of the disclosure;

FIG. 13 is a view illustrating an example of a result of a time synchronization operation in a session configuration in a multi-host case in a UWB payment system according to an embodiment of the disclosure;

FIGS. 14A, 14B, and 14C are views illustrating an example of operations of a user terminal in a session configuration in a multi-host case in a UWB payment system according to various embodiments of the disclosure;

FIGS. 15A and 15B are views illustrating an example of operations of a user terminal in a session configuration in a multi-host case in a UWB payment system according to various embodiments of the disclosure;

FIGS. 16A, 16B, 16C, and 16D are views illustrating an example of operations of a user terminal in a session configuration in a multi-host case in a UWB payment system according to various embodiments of the disclosure;

FIGS. 17A and 17B are views illustrating a data transmission/reception operation between a host terminal and a user terminal in a session configuration in a multi-host case in a UWB payment system according to various embodiments of the disclosure;

FIGS. 18A, 18B, 18C, and 18D are views illustrating a timer setting operation in a session configuration in a multi-host case in a UWB payment system according to various embodiments of the disclosure;

FIG. 19 is a flowchart illustrating a method by an electronic device according to an embodiment of the disclosure;

FIG. 20 is a flowchart illustrating a method by an electronic device according to an embodiment of the disclosure;

FIG. 21 is a view illustrating a structure of an electronic device according to an embodiment of the disclosure;

FIG. 22 is a view illustrating a structure of an electronic device according to an embodiment of the disclosure;

FIG. 23 is a view illustrating a structure of an electronic device according to an embodiment of the disclosure; and

FIG. 24 is a view illustrating a structure of an electronic device according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by computer program instructions. Since the computer program instructions may be equipped in a processor of a general-use computer, a special-use computer or other programmable data processing devices, the instructions executed through a processor of a computer or other programmable data processing devices generate means for performing the functions described in connection with a block(s) of each flowchart. Since the computer program instructions may be stored in computer-available or computer-readable memory that may be oriented to a computer or other programmable data processing devices to implement a function in a specified manner, the instructions stored in the computer-available or computer-readable memory may produce a product including an instruction means for performing the functions described in connection with a block(s) in each flowchart. Since the computer program instructions may be equipped in a computer or other programmable data processing devices, instructions that generate a process executed by a computer as a series of operational steps are performed over the computer or other programmable data processing devices and operate the computer or other programmable data processing devices may provide operations for executing the functions described in connection with a block(s) in each flowchart.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more central processing unit (CPUs) in a device or secure multimedia card. According to embodiments of the disclosure, a “ . . . unit” may include one or more processors.

As used herein, the term ‘terminal’ or ‘device’ may also be referred to as a mobile station (MS), user equipment (UE), user terminal (UT), terminal, wireless terminal, access terminal (AT), subscriber unit, subscriber station (SS), wireless device, wireless communication device, wireless transmit/receive unit (WTRU), mobile node, or mobile or may be referred to in other terms. Various embodiments of the terminal may include cellular phones, smart phones with wireless communication capabilities, personal digital assistants (PDAs) with wireless communication capabilities, wireless modems, portable computers with wireless capabilities, capturing/recording/shooting/filming devices, such as digital cameras, having wireless communication capabilities, game players with wireless communications capabilities, music storage and playback home appliances with wireless communications capabilities, Internet home appliances capable of wireless Internet access and browsing, or portable units or terminals incorporating combinations of those capabilities. Further, the terminal may include a machine to machine (M2M) terminal and a machine-type communication (MTC) terminal/device, but is not limited thereto. In the disclosure, the terminal may be referred to as an electronic device or simply as a device.

Hereinafter, the operational principle of the disclosure is described below with reference to the accompanying drawings. When determined to make the subject matter of the disclosure unnecessarily unclear, the detailed description of known functions or configurations may be skipped in describing embodiments of the disclosure. The terms as used herein are defined considering the functions in the disclosure and may be replaced with other terms according to the intention or practice of the user or operator. Therefore, the terms should be defined based on the overall disclosure.

Hereinafter, embodiments of the disclosure are described in detail with reference to the accompanying drawings. Further, although a communication system using UWB is described in connection with embodiments of the disclosure, as an example, embodiments of the disclosure may also apply to other payment systems with similar technical background or features. For example, a communication system using Bluetooth or ZigBee may be included therein. Further, embodiments of the disclosure may be modified in such a range as not to significantly depart from the scope of the disclosure under the determination by one of ordinary skill in the art and such modifications may be applicable to other communication systems.

When determined to make the subject matter of the disclosure unclear, the detailed description of the known art or functions may be skipped. The terms as used herein are defined considering the functions in the disclosure and may be replaced with other terms according to the intention or practice of the user or operator. Therefore, the terms should be defined based on the overall disclosure.

In general, wireless sensor network technology is largely divided into a wireless local area network (WLAN) technology and a wireless personal area network (WPAN) technology according to the recognition distance. In this case, WLAN is a technology based on IEEE 802.11 which enables access to the backbone network within a radius of about 100 m. WPAN is a technology based on IEEE 802.15 which includes Bluetooth, ZigBee, and ultra-wide band (UWB). A wireless network in which such a wireless network technology is implemented may include a plurality of electronic devices.

According to the definitions by the Federal Communications Commission (FCC), UWB may refer to a wireless communication technology that uses a bandwidth of 500 MHz or more or a bandwidth corresponding to a center frequency of 20% or more. UWB may mean a band itself to which UWB communication is applied. UWB may enable secure and accurate ranging between devices. Thus, UWB enables relative position estimation based on the distance between two devices or accurate position estimation of a device based on the distance from fixed devices (whose positions are known).

UWB may refer to a short-range high-rate wireless communication technology using a wide frequency band of several GHz or more, low spectral density, and short pulse width (e.g., 1 nsec to 4 nsec) in a baseband state. UWB may mean a band itself to which UWB communication is applied. Hereinafter, a payment method is described based on a UWB communication scheme, but this is merely an example and various wireless communication technologies may be used in practice.

The terminology used herein is provided for a better understanding of the disclosure, and changes may be made thereto without departing from the technical spirit of the disclosure.

“Controller” may be a ranging device that defines and controls ranging control messages (RCM) (or control messages).

“Controlee” may be a ranging device using a ranging parameter in the RCM (or control message) received from the controller.

“Ranging device” may be a device capable of performing UWB ranging. In the disclosure, the Ranging Device may be an Enhanced Ranging Device (ERDEV) defined in IEEE 802.15.4z or a FiRa Device defined by FiRa. The Ranging Device may be referred to as a UWB device.

“out-of-band (OOB) Connector” may be a software component for establishing an out-of-band (OOB) connection (e.g., BLE connection) between Ranging Devices. In the disclosure, the OOB Connector may be a FiRa OOB Connector defined by FiRa.

“Service” may be an implementation of a use case that provides a service to an end-user.

“Initiator” may be a Ranging Device that initiates a ranging exchange.

“Out-Of-Band (OOB)” may be data communication that does not use UWB as an underlying wireless technology.

“UWB Service” may be a software component that provides access to the UWBS.

“UWB Session” may be a period from when the Controller and the Controlee start communication through UWB until the communication stops. A UWB Session may include ranging, data transfer, or both ranging and data transfer.

“UWB Session ID” may be an ID (e.g., a 32-bit integer) that identifies the UWB Session, shared between the controller and the controller.

“One-way ranging (OWR)” may be a ranging scheme using a time difference of arrival (TDoA) localization method. The TDoA method corresponds to a method for locating a mobile device based on a relative arrival time of a single message or multiple messages. For a description of OWR (TDoA), reference may be made to the description of IEEE 802.15.4z. As an example of the OWR scheme, a downlink (DL)-TDoA scheme may be included.

“DL-TDoA (DT)” may be a localization method using TDoA measurement from a plurality of DT-anchors. As an embodiment, the DT-anchors may exchange DT messages (DTMs) (ranging messages) with each other, and the DT-tag may passively receive the DTM. As an embodiment, each DT-tag receiving DTMs may calculate the TDoA using at least one of the reception timestamp of each DTM, the transmission timestamp of DTMs included in the corresponding DTMs, or the reply time included in the DTMs. As an embodiment, the DT-tag may estimate its location based on at least one of the calculated coordinates of TDoA and DT-anchors.

“Two-way ranging (TWR)” may be a ranging scheme capable of estimating a relative distance between two devices by measuring time of flight (ToF) through the exchange of ranging messages between the two devices. The TWR scheme may be one of double-sided two-way ranging (DS-TWR) and single-sided two-way ranging (SS-TWR). SS-TWR may be a procedure for performing ranging through one round-trip time measurement. DS-TWR may be a procedure for performing ranging through two round-trip time measurements. For a description of SS-TWR and DS-TWR, reference may be made to the description of IEEE 802.15.4z.

“UWB message” may be a message including a payload IE transmitted by the UWB device (e.g., ERDEV).

The “ranging message” may be a message transmitted by a UWB device (e.g., ERDEV) in a UWB ranging procedure. For example, the ranging message may be a message, such as a ranging initiation message (RIM), a ranging response message (RRM), a ranging final message (RFM), or a measurement report message (MRM), transmitted by a UWB device (e.g., ERDEV) in a specific phase of the ranging round. A ranging message may include one or more UWB messages. If necessary, a plurality of ranging messages may be merged into one message. For example, in the case of non-deferred DS-TWR ranging, RFM and MRM may be merged into one message in a ranging final phase.

“UWB channel” may be one of candidate UWB channels allocated for UWB communication. Candidate UWB channels allocated for UWB communication may be channels allocated for UWB communication defined in IEEE 802.15.4/4z. The UWB channel may be used for UWB ranging and/or transaction. For example, the UWB channel may be used for transmission/reception of a ranging frame RFRAME and/or transmission/reception of a data frame.

“Narrow band (NB) channel” may be a channel having a narrower bandwidth than the UWB channel. The NB channel may be used to assist UWB communications. The NB channel may be a subchannel of one of the candidate UWB channels allocated for UWB communication or a channel using a specific bandwidth of another available band (e.g., a portion of an industrial, scientific and medical (ISM) band). Candidate UWB channels allocated for UWB communication may be channels allocated for UWB communication defined in IEEE 802.15.4/4z. The NB channel may be used for advertising, device discovery, and/or connection setup for additional parameter negotiation/authentication. For example, the NB channel may be used for transmission and reception of an advertisement message, an additional advertising message, a connection request message, and/or a connection confirmation message. As an embodiment, one or a plurality of NB channels may be operated together.

When determined to make the subject matter of the disclosure unnecessarily unclear, the detailed description of related known functions or features may be skipped in describing the disclosure.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

Hereinafter, various embodiments of the disclosure are described with reference to the accompanying drawings.

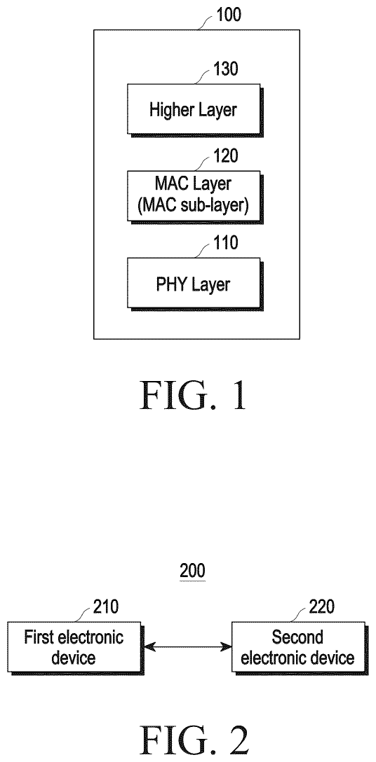

FIG. 1 illustrates an example architecture of an electronic device according to an embodiment of the disclosure.

In the disclosure, the electronic device may be one of various types of electronic devices. For example, the electronic device may be a portable device (e.g., a UE, a smartphone, a wearable device, a vehicle, or a tag device) or a stationary device (e.g., a door lock or an anchor device).

Referring to FIG. 1, the electronic device 100 may include a PHY layer 110, a MAC layer (MAC sublayer) 120, and/or a higher layer 130.

### (1) PHY Layer

The PHY layer 110 may include a low-level control entity and at least one transceiver. In this disclosure, the transceiver may be referred to as an RF transceiver or a radio transceiver.

As an embodiment, at least one transceiver may include a first transceiver supporting UWB communication (e.g., 802.15.4z-based UWB communication), a second transceiver supporting NB communication using a narrower bandwidth than that of UWB communication, and/or a third transceiver supporting other communication technologies (e.g., Bluetooth or BLE). In this disclosure, the first transceiver may be referred to as a UWB transceiver. The second transceiver may be referred to as an NB transceiver. The third transceiver may be referred to as an OOB transceiver. According to embodiments, one transceiver may support a plurality of communication technologies. For example, one transceiver may support UWB communication and NB communication.

In an embodiment, the PHY layer 110 may support at least one of the following functions.
Transceiver activation and deactivation function (transceiver on/off function)
Energy detection function
Channel selection function
Clear channel assessment (CCA) function
Synchronization function
Low-level signaling function
UWB ranging, positioning and localization functions
Spectrum resource management function
Function to transmit/receive packets through physical medium

### (2) MAC Layer

The MAC layer 120 provides an interface between the upper layer 130 and the PHY layer 110.

In an embodiment, the MAC layer 120 may provide two services as follows.
MAC data service: A service that enables transmission and reception of MAC protocol data unit (PDU) through the PHY
MAC management service: Service interfacing to MAC sublayer management entity (MLME) service access point (SAP) (MLME-SAP)

In an embodiment, the MAC layer 120 may support at least one of the following functions.
Device discovery and connection setup function
Channel access function (function of access to physical channel (e.g., NB channel/UWB channel/OOB channel))
Synchronization function
Interference mitigation function based on energy detection
Functions related to NB signaling
Guaranteed timeslot (GTS) management function
Frame delivery function
UWB ranging function
PHY parameter change notification function
Security function

### (3) Upper Layer

The upper layer 130 may include a network layer providing functions, such as network configuration and message routing, and/or an application layer providing an intended function of the device. In an embodiment, the application layer may be a UWB-enabled application layer for providing a UWB service.

FIG. 2 illustrates a communication system including a plurality of electronic devices according to an embodiment of the disclosure.

Referring to FIG. 2, a communication system 200 may include a first electronic device 210 and a second electronic device 220. As an embodiment, the first electronic device 210 and/or the second electronic device 220 may be the electronic device 100 of FIG. 1.

The first electronic device 210 may communicate with the second electronic device 220 for device discovery, connection setup, ranging (e.g., UWB ranging), data communication, and/or other purposes.

The first electronic device 210 may communicate with the second electronic device 220 according to a preset communication scheme (technology). For example, the first electronic device 210 may perform wireless communication with the second electronic device 220 using a UWB communication scheme, an NB communication scheme, and/or an OOB communication scheme.

In the disclosure, the UWB communication scheme may perform communication through at least one of candidate UWB channels allocated for WB communication. Example candidate UWB channels allocated for UWB communication may be shown in Table 1 below.

TABLE 1

| Band | Channel | Center | Band | |
|---|---|---|---|---|
| group | number | frequency, f_{c} | width | |
| (decimal) | (decimal) | (MHz) | (MHz) | Mandatory/Optional |
| 0 | 0 | 499.2 | 499.2 | Mandatory below 1 |
| | | | | GHz |
| 1 | 1 | 3494.4 | 499.2 | Optional |
| | 2 | 3993.6 | 499.2 | Optional |
| | 3 | 4492.8 | 499.2 | Mandatory in low |
| | | | | band |
| | 4 | 3993.6 | 1331.2 | Optional |
| 2 | 5 | 6489.6 | 499.2 | Optional |
| | 6 | 6985.8 | 499.2 | Optional |
| | 7 | 6489.6 | 1081.6 | Optional |
| | 8 | 7488.0 | 499.2 | Optional |
| | 9 | 7987.2 | 499.2 | Mandatory in high |
| | | | | band |
| | 10 | 8486.4 | 499.2 | Optional |
| | 11 | 7987.2 | 1331.2 | Optional |
| | 12 | 8985.6 | 499.2 | Optional |
| | 13 | 9484.8 | 499.2 | Optional |
| | 14 | 9984.0 | 499.2 | Optional |
| | 15 | 9484.8 | 1354.97 | Optional |

a) Note that bands indicate a sequence of adjacent HRP UWB center frequencies: band 0 is the sub-gigahertz channel, band 1 has the low-band HRP UWB channels, and band 2 has the high-band channels.

As an embodiment, at least one of the channels in Table 1 may be assigned as a UWB channel supported by a UWB transceiver (e.g., transceiver 2410). For example, channel number 5 and/or 9 of Table 1 may be allocated as a UWB channel.

NB communication may support at least one NB channel having a narrower bandwidth than the UWB channel.

In an embodiment, the NB channel may be a subchannel of one of the candidate UWB channels allocated for UWB communication. Example candidate UWB channels allocated for UWB communication may be shown in Table 1 above.

In another embodiment, the NB channel may be a channel using a specific bandwidth of another available band (e.g., some of industrial, scientific and medical (ISM) bands).

Meanwhile, as in Table 1 above, the candidate UWB channels mainly have a bandwidth of 500 MHz or more. Therefore, using it as it is may be disadvantageous in power spectral density (energy detection), so that it may be needed to divide the corresponding channel into a plurality of subchannels (NB channels) and use them. For example, NB channels need to be used for device discovery (or advertisement) and/or connection setup.

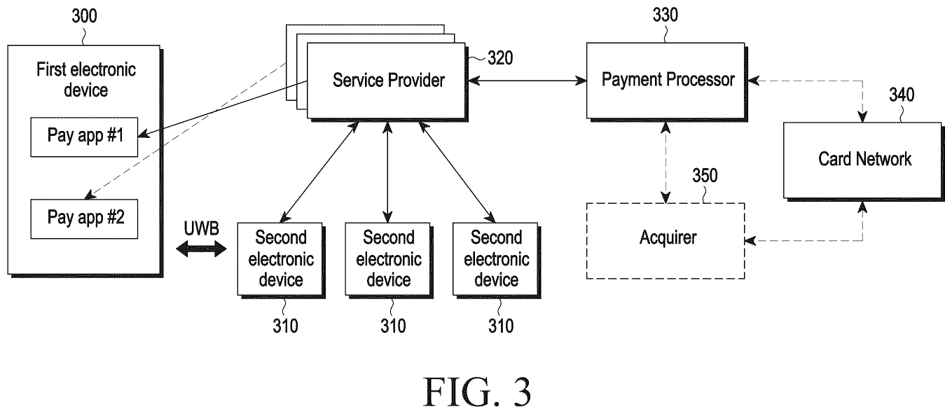

FIG. 3 illustrates a payment system using UWB according to an embodiment of the disclosure.

Referring to FIG. 3, a payment system using UWB (UWB payment system) may include a first electronic device(s) 300, at least one second electronic device 310, a service provider(s) 320, and/or a payment processor(s) 330. The payment processor 330 may be connected to a card network 340 and/or an acquirer 350. The acquirer 350 is an optional component and may serve to acquire slips and process payment on behalf of affiliated stores.

The first electronic device 300 may be an electronic device (terminal) that performs UWB communication with the at least one second electronic device 310. For example, the first electronic device 300 may be an electronic device serving as a responder that transmits a response message in response to an initiation message for UWB ranging received from the at least one second electronic device 310. In an embodiment, the first electronic device 300 may be a mobile device (e.g., a mobile phone, a smart watch, a smart bracelet, etc.) of the user using a payment-related service provided at the place of business of the service provider 320. In an embodiment, the first electronic device 300 may include at least one payment application provided by at least one service provider 320. For example, the first electronic device 300 may include a first payment application (pay app #1) provided by the first service provider 320 and/or a second payment application (pay app #2) provided by the first service provider 320 or the second service provider 320.

The at least one second electronic device 310 may be an electronic device (terminal) that performs UWB communication with the first electronic device 300. For example, the at least one second electronic device 310 may be an electronic device serving as an initiator that transmits an initiation message for UWB ranging to the first electronic device 300. In an embodiment, the at least one second electronic device 310 may be a payment device (e.g., a point of sales (POS) device) installed in the place of business (business place) of the service provider 320 and/or an electronic device (gate device) that identifies entry/exit of the user through UWB ranging at the gate.

The service provider 320 may be the owner for a specific payment application provided to the first electronic device 300 and may be an entity (e.g., a server) responsible for managing the at least one second electronic device 310. In the disclosure, the service provider 320 may also be referred to as a service provider 320 device, a service provider 320 server, or a service provider 320 backend server.

The payment processor 330 may be an entity (e.g., a server) that receives payment information about the at least one second electronic device 310 and, when there is no payment information, transfers payment information to the card network 540. Further, the payment processor 330 may be responsible for operating the at least one second electronic device 310.

In FIG. 3, the service provider 320 and the payment processor 330 are shown as separate entities, but this merely logically separates the two components. Accordingly, the service provider 320 device and the payment processor 330 may be configured as a single entity that performs the above-described functions of the service provider 320 device and the payment processor 330 together. Further, the payment processor 330 and the acquirer 350 may also be configured as a single entity.

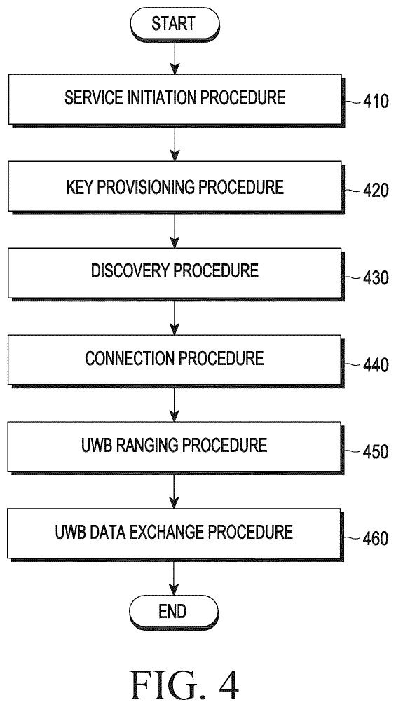

FIG. 4 illustrates a method for providing a UWB-related service according to an embodiment of the disclosure.

Referring to FIG. 4, a method for providing a UWB-related service (a method for providing a UWB service) may include a service initiation procedure 410, a key provisioning procedure 420, a discovery procedure 430, a connection procedure 440, a UWB ranging procedure 450, and/or a UWB data exchange procedure 460. Meanwhile, according to an embodiment, some procedures may be omitted or additional procedures may be added, and the procedures may be performed in a different order than that shown in FIG. 4. For example, the key provisioning procedure 420, the discovery procedure 430 and connection procedure 440, or the discovery procedure 430 and connection procedure 440 may be omitted.

In an embodiment, the UWB-related service may be a payment service using UWB ranging.

Referring to FIG. 4, the service initiation procedure 410 is a procedure for initiating a UWB-related service, and may include, e.g., an operation for determining a BLE profile and/or a UWB profile for providing a UWB-related service.

The key provisioning procedure 420 may be a procedure for issuing and distributing security information (e.g., keys or certificate) to provide secured UWB-related services. In an embodiment, the security information may be issued and distributed by a service provider providing a UWB-related service (or application).

The discovery procedure 430 is a procedure for discovering a UWB device, and may be performed through out-of-band (OOB) communication (e.g., BLE communication) or in-band communication (e.g., UWB communication).

The connection procedure 440 may be a procedure for establishing a UWB channel or session by exchanging parameters for establishing a channel or session for UWB communication.

The UWB ranging procedure 450 may be a procedure for measuring a position/distance between electronic devices according to a UWB communication scheme.

The UWB ranging procedure 450 includes an operation in which the second electronic device transmits an initiation message (e.g., ranging initiation message) to the first electronic device and an operation in which the first electronic device receives a response message (e.g., a ranging response message) corresponding to the initiation message from the second electronic device. In an embodiment, the ranging initiation message may be a first message transmitted to initiate ranging exchange.

For a detailed description of the above-described UWB ranging procedure 450, reference the descriptions of IEEE Std 802.15.4z-2020 and FIRA CONSORTIUM UWB MAC TECHNICAL REQUIREMENTS.

The UWB data exchange procedure 460 may be a procedure for exchanging information/data for a UWB-related service between electronic devices by a UWB communication scheme. In an embodiment, the UWB data exchange procedure 460 may exchange information/data through a transaction information message and a payment information message.

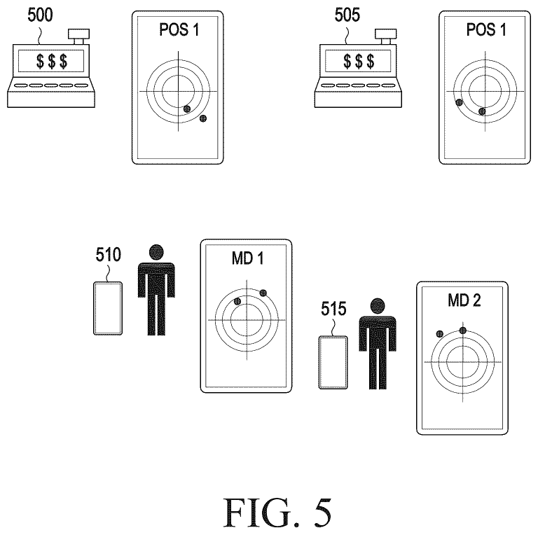

FIG. 5 is a view illustrating a multi-POS scenario in a UWB payment system according to an embodiment of the disclosure.

Referring to FIG. 5, a UWB payment system may include a first host terminal 500, a second host terminal 505, a first user terminal 510, and a second user terminal 515. However, the UWB payment system, which is a Multi-POS in FIG. 5, is an example, and the UWB payment system may include a plurality of host terminals and a plurality of user terminals.

The first host terminal 500 and the second host terminal 505 of FIG. 5 may correspond to the second electronic device 310 illustrated in FIG. 3.

Time resource allocation is necessary to implement a UWB-based payment system in a multi-POS scenario. In other words, allocation of CBR, DS-TWR, and IDT sessions to each of the first host terminal 500 and the second host terminal 505 is required. The content-based ranging (CBR) session may be used for peripheral device discovery. The double-sided two-way ranging (DS-TWR) session may be used for distance measurement with the discovery device. The in-band data transfer (IDT) session may be used to transmit and receive payment data to and from the discovery device.

In the UWB-based payment system of the multi-host, UWB communication-related information may be previously input to each host terminal. In this case, the plurality of host terminals may perform UWB activation and time synchronization between host terminals. Thereafter, when the user termina (mobile device) enters the UWB payment space, it may transmit and receive UWB information through out-of-band (OOB) communication and activate UWB communication. Through UWB communication, the host terminal may discover the user terminal MD in the CBR session. The host terminal may measure the distance between the host terminal and the user terminal and an angle of relative (AoA) in the TWR session. Based on the measured distance and the AoA result, one of the host terminals may perform payment with the user terminal MD in the IDT session.

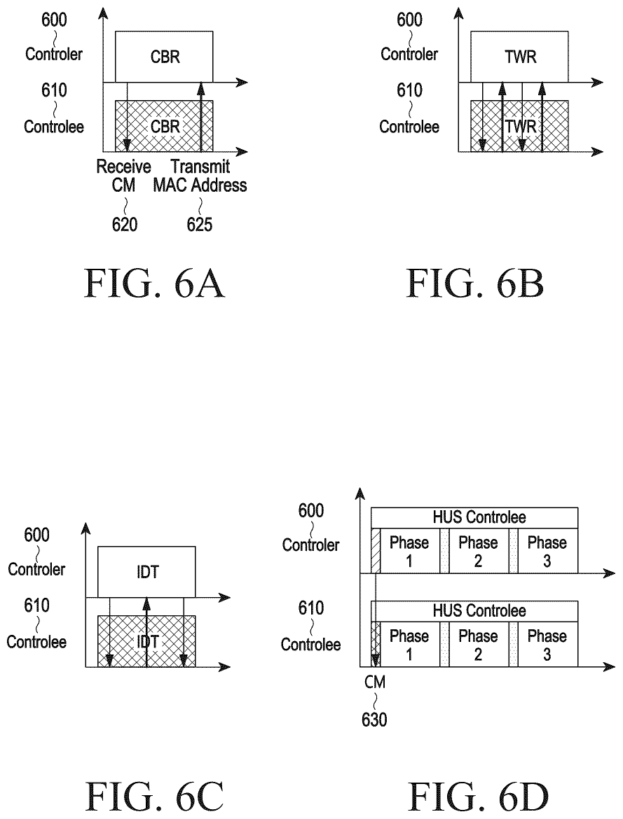

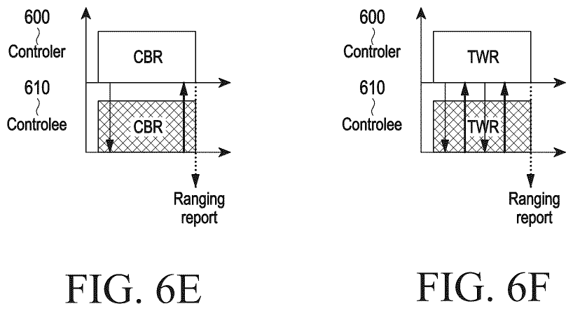

FIGS. 6A, 6B, 6C, 6D, 6E, and 6F are views illustrating a configuration of a session for each process of UWB communication according to various embodiments of the disclosure.

FIGS. 6A to 6F illustrate the operations between the controller 600 and the controlee 610 in the UWB communication system. The controller 600 and the controlee 610 illustrated in FIGS. 6A to 6F may correspond to an electronic device capable of performing operations of the first electronic device 210 and the second electronic device 220 illustrated in FIG. 2. The controller 600 may establish a UWB channel or session by exchanging parameters for establishing a channel or session for UWB communication in advance to the controlee 610.

The controller 600 may control devices that have established a corresponding session, and may transmit (e.g., broadcast) a control message CM to the controlee 610 at the start of the session. The controlee 610 receiving the control message CM may perform an operation according to the received control message CM.

FIG. 6A is a view illustrating a content-based ranging (CBR) session configuration during UWB communication according to an embodiment of the disclosure.

The controller 600 may transmit (e.g., broadcast) a control message CM to at least one controlee 610 (620). The controlee 610 receiving the control message CM may transmit the MAC address to the controller 600 (625). The controller 600 may discover the controlee 610 based on the MAC address. In the CBR session, the controller 600 may obtain [distance, MAC address, AoA]. In the CBR session, the controlee 610 may obtain [MAC address, AoA].

FIG. 6B is a view illustrating a double-sided two-way ranging (DS-TWR) session configuration during UWB communication according to an embodiment of the disclosure.

The controller 600 may measure the distance and AoA between the controller 600 and the controlee 610 using UWB communication with at least one controlee 610.

FIG. 6C is a view illustrating an in-band data transfer (IDT) session configuration during UWB communication according to an embodiment of the disclosure.

The controller 600 may transmit and receive data to and from at least one controlee 610 using UWB communication.

FIG. 6D is a view illustrating a hybrid UWB session (HUS) configuration during UWB communication according to an embodiment of the disclosure.

HUS refers to a session in which several sessions are grouped into one session and managed to facilitate HUS time synchronization between devices. The session within the HUS may be referred to as a phase. In the HUS session, the controller 600 may transmit (e.g., broadcast) a control message CM to the controlee 610 at each period (630). The control message CM may be used for transferring phase configuration information in the HUS and synchronizing HUS time between devices.

FIGS. 6E and 6F are views illustrating an operation of transmitting a ranging report in a session configuration of a UWB communication system according to various embodiments of the disclosure.

When the distance measurement is performed in the CBR or TWR session described in FIGS. 6A and 6B, the CBR session or the TWR session is terminated, and the distance measurement value may be reported from the lower layer to the upper layer. In an embodiment, the controller 600 may transmit to the controlee 610, or the controlee 610 may transmit to the controller 600, a ranging report including the distance measurement result after the CBR session or the TWR session is terminated.

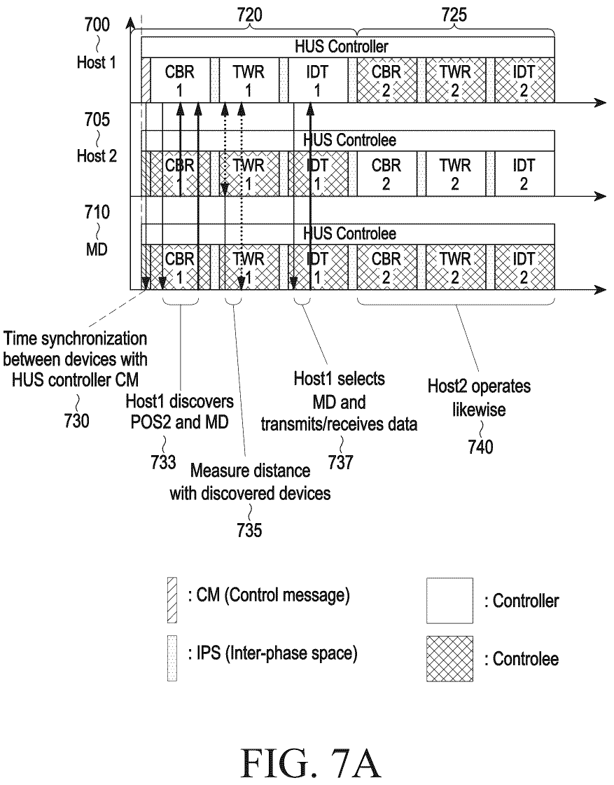

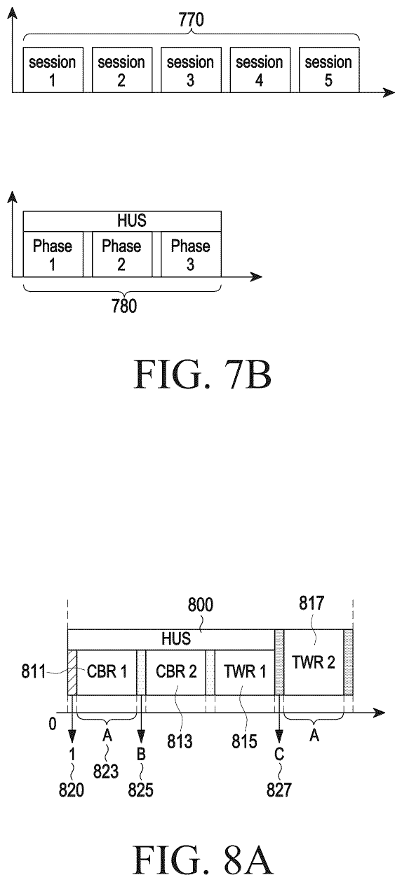

FIGS. 7A and 7B are views illustrating an example of a session configuration in a multi-host case in a UWB payment system according to various embodiments of the disclosure.

Referring to FIG. 7A, the UWB payment system may include a first host terminal (Host 1) 700, a second host terminal (Host 2) 705, and a user terminal (MD) 710. In FIG. 7A, the first host terminal 700 or the second host terminal 705 may operate as a controller in some sessions, and the first host terminal 700, the second host terminal 705, and the user terminal 710 may operate as controlees in some sessions. The first host terminal 700 may establish a session with the second host terminal 705 and the user terminal 710.

The first host terminal 700, the second host terminal 705, and the user terminal 710 may use seven sessions per device. For example, each terminal may configure a session with one HUS controller or controlee session and seven phases (CBR1, TWR1, IDT1, CBR2, TWR2, and IDT2). An interval of the seven sessions used per device may be referred to as a ranging interval.

Referring to FIG. 7A, the first host terminal 700 may operate as a controller in the CBR1, TWR1, and IDT1 phases (a first period 720) to perform discovery of another terminal, distance measurement, and data transmission/reception. The second host terminal 705 may operate as a controller in the CBR2, TWR2, and IDT2 phases (a second period 725) to perform discovery, distance measurement, and data transmission/reception of other terminals.

Referring to FIG. 7A, in operation 730, the first host terminal 700 may perform time synchronization between devices with an HUS controller control message CM. In operation 733, the first host terminal 700 may discover the second host terminal 705 and the user terminal 710 in the CBR1 phase. In operation 735, the first host terminal 700 may perform distance measurement with the discovered terminals in the TWR1 phase. In operation 737, the first host terminal 700 may select the user terminal 710 in the IDT1 phase to transmit and receive data. In operation 740, the second host terminal 705 may perform operations such as operations 730 to 740 in the CBR2, TWR2, and IDT2 phases.

FIG. 7B illustrates a session configuration of an electronic device considering hardware specifications.

Referring to FIG. 7B, considering hardware specifications, the electronic device may establish up to five sessions 770 and establish up to three phases 780 within the HUS. Therefore, the disclosure proposes a session establishment method for efficient UWB communication for each terminal in a payment system using UWB communication where a multi-host terminal is present, considering the hardware specifications described in connection with FIG. 7B.

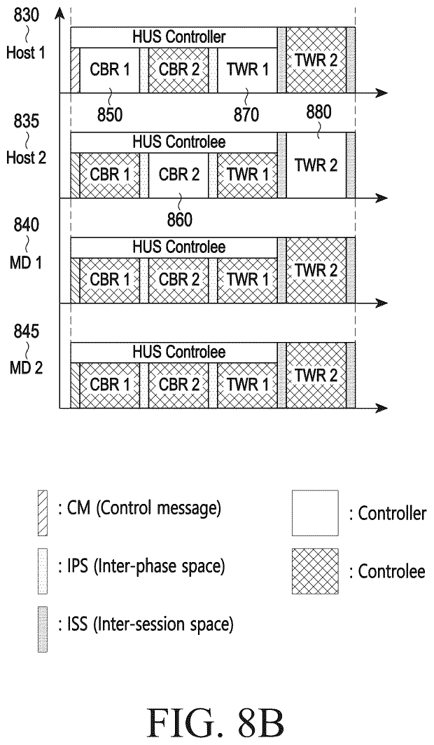

FIGS. 8A and 8B are views illustrating an example of a session configuration in a multi-host case in a UWB payment system according to various embodiments of the disclosure.

FIG. 8A is a view illustrating an example of a session configuration which may be established by an electronic device according to an embodiment of the disclosure.

Referring to FIG. 8A, the electronic device may establish five sessions 800, 811, 813, 815, and 817 per ranging interval. In other words, the electronic device may establish a session to include two sessions (HUS 800 and TWR2 817) and three phases (CBR1 811, CBR2 813, and TWR1 815). In an embodiment, the electronic device may allocate CBR1 811, CBR2 813, and TWR1 815 phases within the HUS session 800, and may allocate a TWR2 session 817.

In an embodiment, HUS session 800 includes a control message section 820. In an embodiment, the phase and session may be indicated as having an interval of Ams 823, the inter-phase space (IPS) as having Bms 825, and the inter-session space (ISS) as having Cms 827. The electronic device may repeat the ranging interval with the session configuration illustrated in FIG. 8A.

Referring to FIG. 8B, an example of a session configuration in a case of a multi-host in a UWB payment system is shown. The UWB payment system may include a first host terminal (Host 1) and 830, a second host terminal (Host 2) 835, a first user terminal (MD) 840, and a second user terminal (MD) 845. In an embodiment, the first host terminal (Host 1) 830 may be set as an HUS controller. In an embodiment, the first host terminal 830 and the second host terminal 835 may be alternately configured as a controller in CBR1, CBR2, TWR1 phase, and TWR2 sessions. For example, the first host terminal 830 may be configured to operate as a controller in the CBR1 phase 850 and the TWR1 phase 870, and the second host terminal 835 may be configured to operate as a controller in the CBR2 phase 860 and the TWR2 session 880. In an embodiment, data may be transmitted and received in the TWR 1 phase or the TWR 2 session. In an embodiment, data may be transmitted and received in a piggyback manner in the TWR 1 phase or the TWR 2 session.

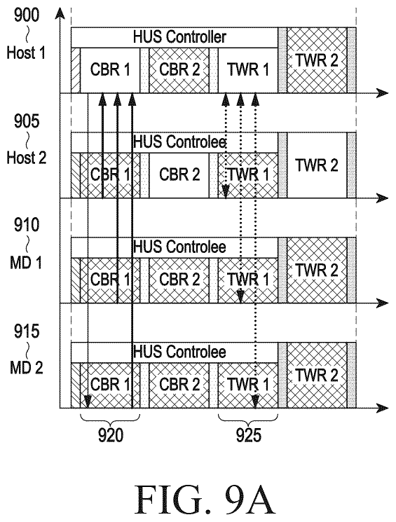

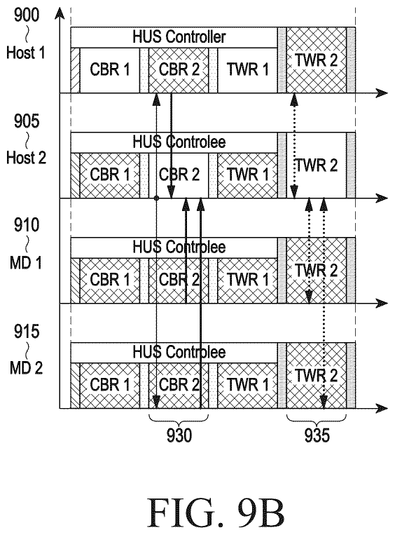

FIGS. 9A and 9B are views illustrating an example of operations of host terminals and a user terminal in a session configuration in a multi-host case in a UWB payment system according to various embodiments of the disclosure.

The first host terminal 500 and the second host terminal 505 in FIGS. 9A and 9B may correspond to the second electronic device 310 illustrated in FIG. 3.

Referring to FIGS. 9A and 9B, the UWB payment system may include a first host terminal (Host 1) and 900, a second host terminal (Host 2) 905, a first user terminal (MD) 910, and a second user terminal (MD) 915. FIGS. 9A and 9B illustrate an example of operations between host terminals and a user terminal in the session configuration described in connection with FIGS. 8A and 8B.

Referring to FIG. 9A, the first host terminal 900 operates as a controller in the CBR1 phase and may search for peripheral devices (920). The first host terminal 900 operates as a controller in the TWR 1 phase, and may perform distance measurement in the TWR1 session with the device discovered in the CBR1 phase (925).

Referring to FIG. 9B, the second host terminal 905 may operate as a controller in the CBR2 phase and may search for peripheral devices (930). The second host terminal 905 may operate as a controller in the TWR2 session, and may perform distance measurement in the TWR2 session with the device discovered in the CBR2 phase (935).

### Time Synchronization Operation Between Host Terminals

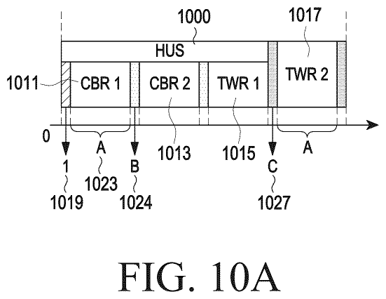

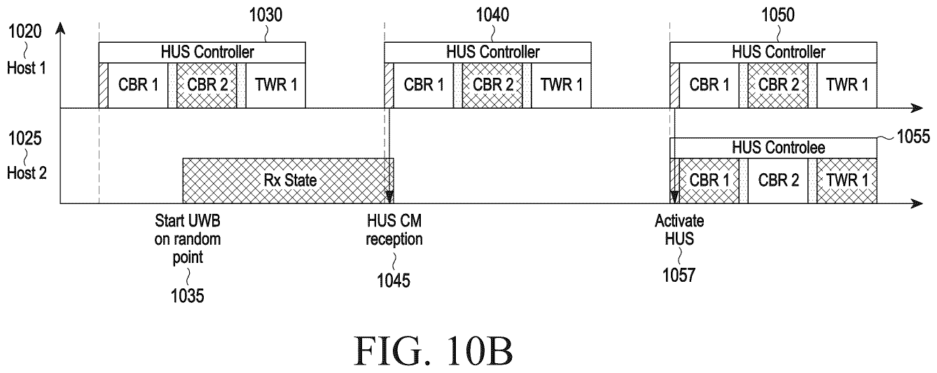

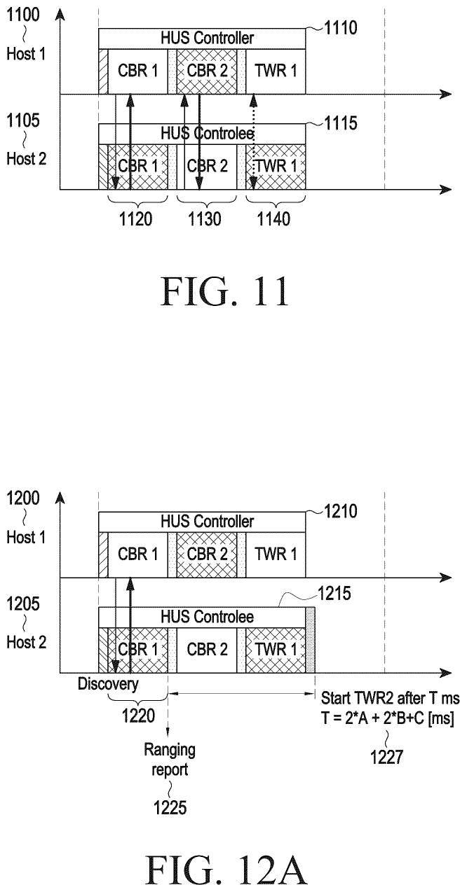

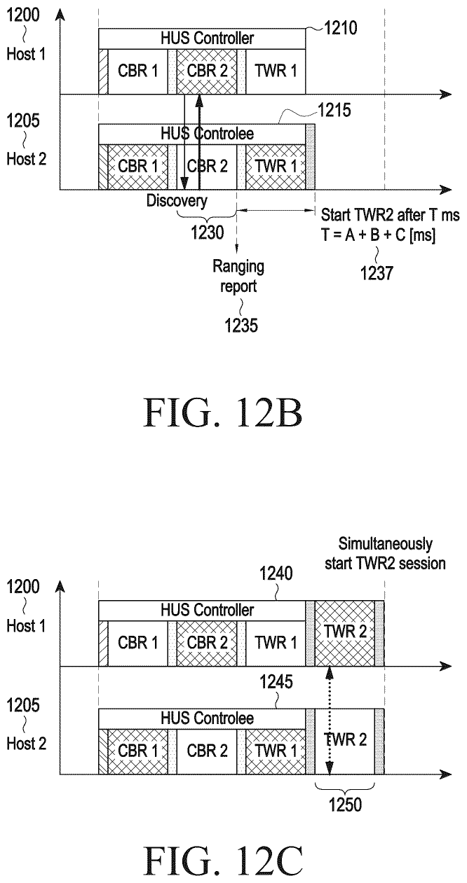

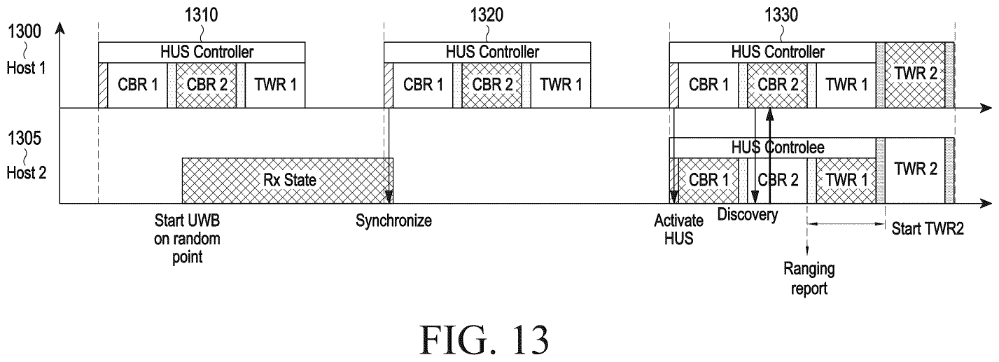

Hereinafter, in FIGS. 10A, 10B, 11, 12A, 12B, 12C, and 13, an example of a time synchronization operation between host terminals in a multi-host case in a UWB payment system according to an embodiment is described. In the description of FIGS. 10A, 10B, 11, 12A, 12B, 12C, and 13, the UWB payment system includes a first host terminal, a second host terminal, and a user terminal, but the number of terminals is not limited thereto. The time synchronization operation between the host terminals (between the first host terminal and the second host terminal) may be performed as follows, and each operation is described in the related drawings.
1. Pre-establishment of session before UWB communication (FIG. 10A)
2. first host terminal and second host terminal initiate HUS session (FIG. 10B)
3. phase (CBR1, CBR2, TWR1) operations in HUS session (FIG. 11)
4. activation of TWR2 session (FIGS. 12A, 12B, and 12C)
5. synchronization between host terminals completed (FIG. 13)

FIGS. 10A and 10B are views illustrating an example of an operation of establishing a session and initiating the session in a multi-host case in a UWB payment system according to various embodiments of the disclosure.

FIG. 10A is a view illustrating an example of a session configuration in a multi-host case in a UWB payment system according to an embodiment of the disclosure.

Before UWB communication, information (session configuration, length, type) about the session and ranging interval may be preset for each host terminal and user terminal.

Referring to FIG. 10A, the terminal may establish five sessions 1000, 1011, 1013, 1015, and 1017 per ranging interval. In other words, the terminal may establish a session to include two sessions (HUS 1000 and TWR2 1017) and three phases (CBR1 1011, CBR2 1013, and TWR1 1015). In an embodiment, the terminal may allocate CBR1 1011, CBR2 1013, and TWR1 1015 phases within the HUS session 1000, and may allocate a TWR2 session 1017.

In an embodiment, HUS session 800 includes a control message section 1019. In an embodiment, the phase and session may be indicated as having an interval of Ams 1023, the inter-phase space (IPS) as having Bms 1024, and the inter-session space (ISS) as having Cms 1027. The electronic device may repeat the ranging interval with the session configuration illustrated in FIG. 10A.

FIG. 10B is a view illustrating an example of initiating a session in a multi-host case in a UWB payment system according to an embodiment of the disclosure.

The first host terminal 1020 may initiate the HUS session 1030 as the HUS controller. The HUS session 1030 may include CBR1, CBR2, and TWR1 phases. The second host terminal 1025 may activate UWB communication and listen to a control message CM in an Rx state (1035). In other words, the second host terminal 1025 may activate UWB communication and wait for the reception of the control message CM in the Rx state.

When the first host terminal 1020 initiates the HUS session 1040 as the HUS controller and transmits the HUS control message CM in the next cycle, the second host terminal 1025 may receive the HUS control message CM (1045). The second host terminal 1025 may perform a time synchronization operation with the first host terminal 1020 based on the received HUS control message. In the next cycle, the first host terminal 1020 may initiate the HUS session 1050 as the HUS controller, and the HUS second host terminal 1025 may initiate the HUS session 1055 as the HUS controlee based on the information received via the OOB. The first host terminal 1020 may activate the HUS through the control message (1057).

FIG. 11 is a view illustrating an example of a time synchronization operation in a session configuration in a multi-host case in a UWB payment system according to an embodiment of the disclosure.

The first host terminal (host 1) 1100 and the second host terminal (host 2) 1105 illustrated in FIG. 11 may correspond to the first host terminal 1020 and the second host terminal 1025 illustrated in FIG. 10B.

The first host terminal 1100 may initiate the HUS controller session 1110, and the second host terminal 1105 may initiate the HUS controlee session 1115. The HUS controller session 1110 and the HUS controlee session 1115 each may include CBR1, CBR2, and TWR1 phases. The first host terminal 1100 operates as a controller in the CBR1 phase 1120, and may discover at least one controlee (e.g., the second host terminal 1105). In other words, the first host terminal 1100 may collect address information about peripheral controlees. For example, the first host terminal 1100 may transmit (e.g., broadcast) a control message to the controlees and receive a MAC address from the controlees. The second host terminal 1105 may operate as a controller in the CBR2 phase 1130, and may discover at least one controlee (e.g., the first host terminal 1100). In other words, the second host terminal 1105 may collect address information about the peripheral controlees. The first host terminal 1100 and the second host terminal 1105 may perform distance measurement in the TWR1 phase 1140.

FIGS. 12A, 12B, and 12C are views illustrating an example of a time synchronization operation in a session configuration in a multi-host case in a UWB payment system according to various embodiments of the disclosure.

The first host terminal (host 1) 1200 and the second host terminal (host 2) 1205 illustrated in FIGS. 12A, 12B, and 12C may correspond to the first host terminal and the second host terminal illustrated in FIGS. 10B and 11.

Referring to FIG. 11, when the host terminal is discovered in the CBR1 phase or the CBR2 phase, the first host terminal 1200 and the second host terminal 1205 may output a ranging report upon termination of the CBR1 phase or the CBR2 phase.

In an embodiment, all of the host terminals may execute a timer for initiating a TWR2 session when outputting the ranging report in the CBR1 phase or the CBR2 phase.

In an embodiment, the timer may be set to a time Ts to the inter-session space (ISS) after the HUS session ends, from the time when the ranging report is output. When the timer ends, the first host terminal 1200 and the second host terminal 1205 may simultaneously start the TWR 2 session and perform mutual distance measurement.

In this case, the timer T for starting the TWR2 session may be set with respect to the ranging report output time of the first host terminal 1200 or the ranging report output time of the second host terminal 1205.

Referring to FIGS. 12A, 12B, and 12C, the first host terminal 1200 may initiate a HUS controller session 1210, and the second host terminal 1205 may initiate a HUS controlee session 1215. The HUS controller session 1210 and the HUS controlee session 1215 each may include CBR1, CBR2, and TWR1 phases.

FIG. 12A illustrates a case in which a timer T for starting a TWR2 session is set with respect to a ranging report output time point of the first host terminal 1200.

Referring to FIG. 12A, the first host terminal 1200 may discover the second host terminal 1205 in the CBR1 phase 1220 and output a ranging report 1225 at the end of the CBR1 phase 1220. In an embodiment, the timer T for starting the TWR2 session may be set to T=2A+2B+C (ms) with respect to the time when the ranging report 1225 is output. In other words, the second host terminal 1205 may initiate the TWR2 session, a time of Tms (1227) after the time when the ranging report 1225 is output. As described in connection with FIGS. 10A, 12A, 12B, and 12C may refer to phase and session length (Ams), inter-phase space (IPS) (Bms), and inter-session space (ISS) (Cms).

Referring to FIG. 12B, the second host terminal 1205 may discover the first host terminal 1200 in the CBR2 phase 1230, and output a ranging report 1235 at the end of the CBR2 phase 1230. In an embodiment, time T 1237 of the timer for starting the TWR2 session may be set to T=A+B+C (ms) with respect to the time when the ranging report 1235 is output. In other words, the second host terminal 1205 may initiate the TWR2 session, a time of Tms after the time when the ranging report 1235 is output. As described in connection with FIGS. 10A, 12A, 12B, and 12C may refer to phase and session length (Ams), inter-phase space (IPS) (Bms), and inter-session space (ISS) (Cms).

Referring to FIG. 12C, the first host terminal 1200 and the second host terminal 1205 may simultaneously start the TWR2 sessions 1240 and 1245 at the time when the previously determined timer T expires. The first host terminal 1200 and the second host terminal 1205 may measure a distance or transmit and receive data in the TWR2 session 1250. As the first host terminal 1200 and the second host terminal 1205 simultaneously start the TWR2 sessions 1240 and 1245, the session may be stably driven.

FIG. 13 is a view illustrating an example of a result of a time synchronization operation in a session configuration in a multi-host case in a UWB payment system according to an embodiment of the disclosure.

The first host terminal (host 1) 1300 and the second host terminal (host 2) 1305 illustrated in FIG. 13 may correspond to the first host terminal and the second host terminal illustrated in FIGS. 10B, 11, 12A, 12B, and 12C.

Referring to FIG. 13, the first host terminal 1300 and the second host terminal 1305 may complete synchronization between hosts within a 3*ranging interval (ms) including up to three HUS sessions 1310, 1320, and 1330.

Operations Between Multi-Host Terminals and User Terminal after Synchronization Between Host Terminals

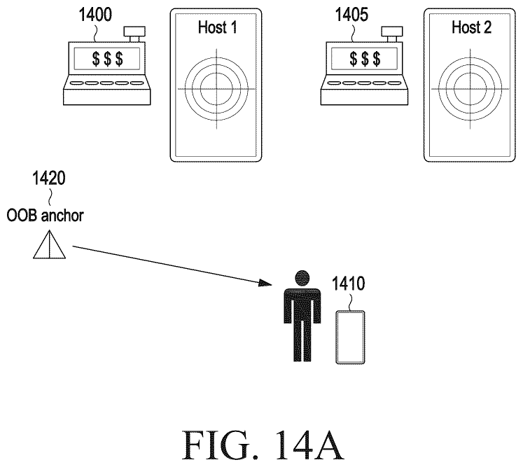

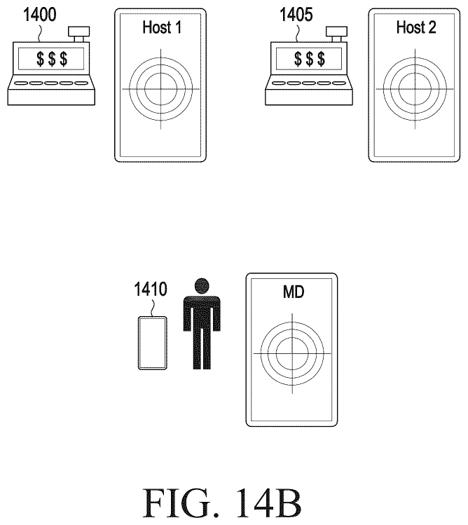

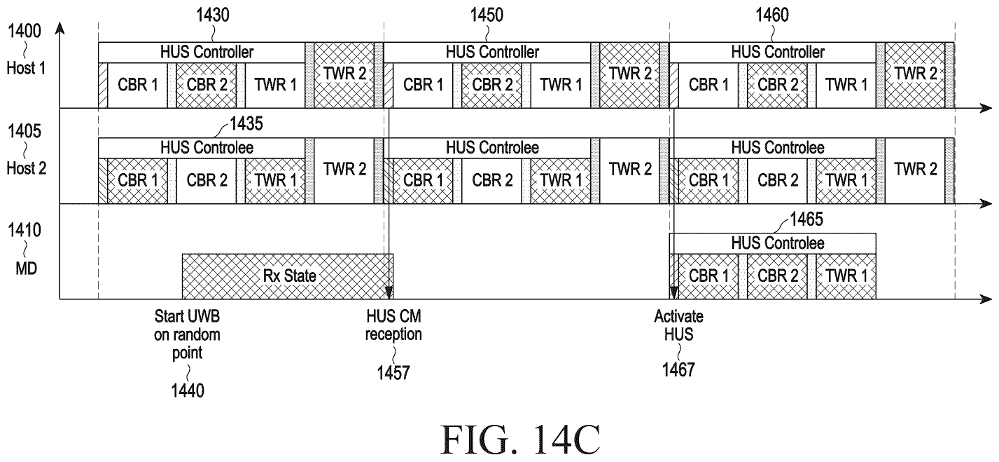

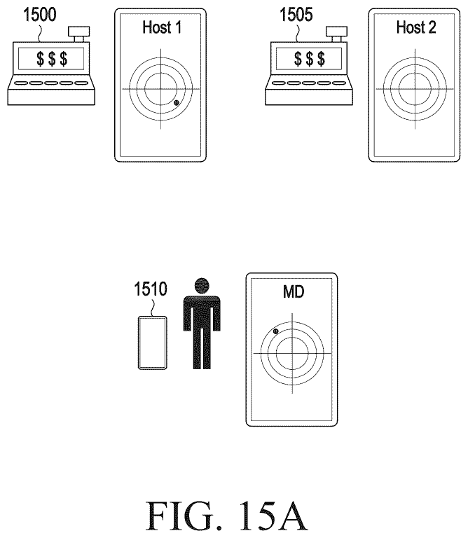

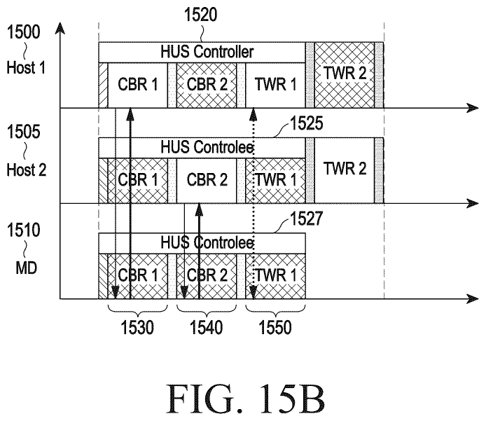

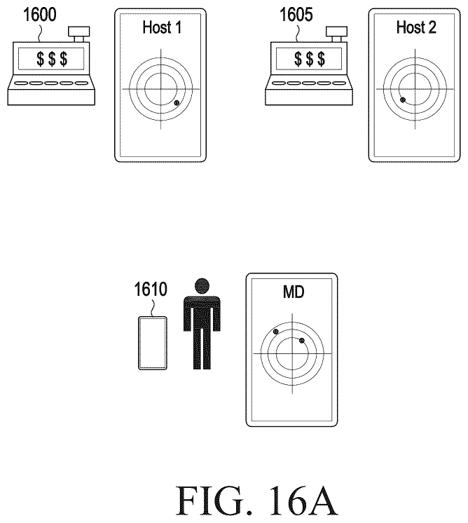

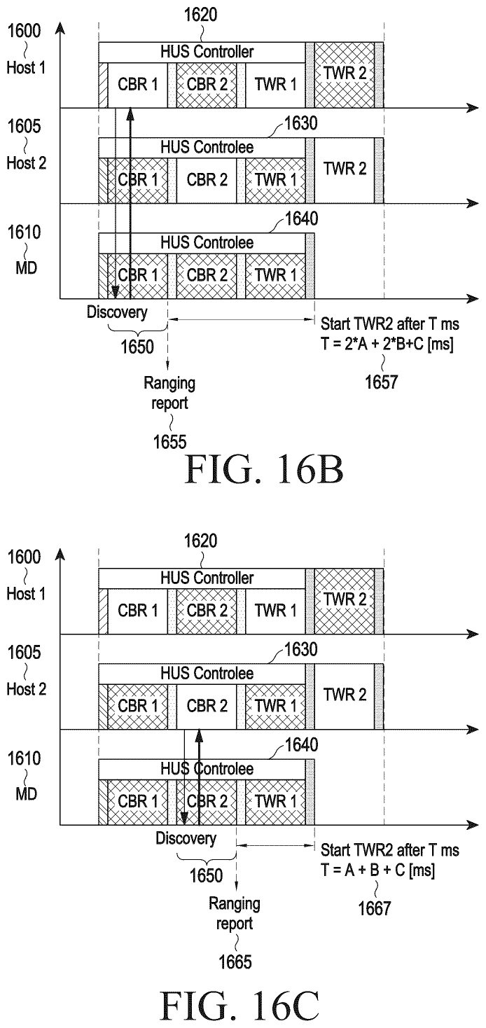

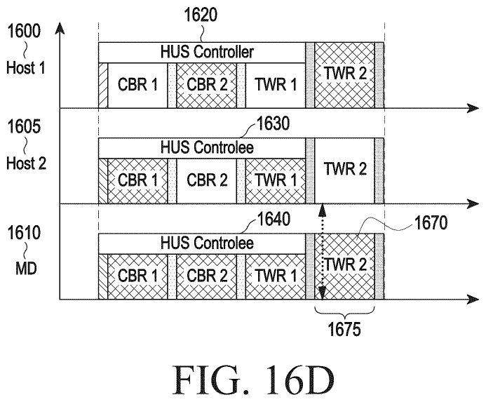

Hereinafter, an example of a synchronization operation between multi-host terminals and a user terminal after synchronization between host terminals according to an embodiment is described in connection with FIGS. 14A, 14B, 15A, 15B, and 16A to 16D. Although the UWB payment system includes a first host terminal, a second host terminal, and a user terminal in the description of FIGS. 14A, 14B, 15A, 15B, and 16A to 16D, the number of terminals is not limited thereto. A time synchronization operation between the multi-host terminals and the user terminal may be performed as follows, and each operation is described in the illustrated drawings.
1. User terminal enters the area of host terminal (FIG. 14A)
2. User terminal initiates the HUS session (FIGS. 14B and 14C)
3. User terminal performs phase operation in the HUS session (FIGS. 15A and 15B)
4. User terminal activates the TWR2 session (FIGS. 16A, 16B, 16C, and 16D)

FIGS. 14A, 14B, and 14C are views illustrating an example of operations of a user terminal in a session configuration in a multi-host case in a UWB payment system according to various embodiments of the disclosure.

FIGS. 14A, 14B, and 14C illustrate an example of an operation for a user terminal to participate in UWB communication after the first host terminal 1400 and the second host terminal 1405 complete time synchronization, as described in connection with FIGS. 10A, 10B, 11, 12A to 12C and 13, according to various embodiments of the disclosure.

FIG. 14A is a view illustrating an example of an operation when a user terminal enters a preset area of a host terminal in a multi-host case in a UWB payment system according to an embodiment of the disclosure.

When the user terminal 1410 enters an area preset by the first host terminal 1400 or the second host terminal 1405, the out-of-band (OOB) anchor 1420 may transmit information about the UWB session (e.g., session configuration, length, type, etc.) and information about the ranging interval to the user terminal 1410.

Referring to FIG. 14B, the user terminal 1410 may enter an area preset by the first host terminal 1400 or the second host terminal 1405, and the out-of-band (OOB) anchor 1420 may initiate UWB communication when receiving information about the UWB session.

FIG. 14C is a view illustrating an example of an operation in which a user terminal enters a preset area of a host terminal and initiates UWB communication in a multi-host case in a UWB payment system according to an embodiment of the disclosure.

Referring to FIG. 14C, the first host terminal 1400 and the second host terminal 1405 may complete time synchronization, the first host terminal 1400 may initiate a HUS controller session (including the CBR1, CBR2, and TWR1 phases) and a TWR2 session 1430, and the second host terminal 1405 may initiate a HUS controlee session (including the CBR1, CBR2, and TWR1 phases) and a TWR2 session 1435. The user terminal 1410 may activate UWB communication and listen to a control message CM in an Rx state (1440). In other words, the user terminal 1410 may activate UWB communication and wait for the reception of the control message CM in the Rx state.

When the first host terminal 1400 initiates the HUS session and TWR2 session 1450 as the HUS controller and transmits the HUS control message CM in the next cycle, the user terminal 1410 may receive the HUS control message CM (1457). The user terminal 1410 may perform a time synchronization operation with the first host terminal 1400 based on the received HUS control message. In the next cycle, the first host terminal 1400 may initiate the HUS session 1460 as the HUS controller, and the user terminal 1410 may initiate the HUS session 1465 as the HUS controlee based on the information received via the OOB. The first host terminal 1400 may activate the HUS through the control message (1467).

FIGS. 15A and 15B are views illustrating an example of operations of a user terminal in a session configuration in a multi-host case in a UWB payment system according to various embodiments of the disclosure.

The first host terminal 1500, the second host terminal 1505, and the user terminal 1510 illustrated in FIGS. 15A and 15B may correspond to the first host terminal, the second host terminal, and the user terminal illustrated in FIGS. 14A, 14B, and 14C.

Referring to FIG. 15A, in the UWB payment system according to an embodiment, the first host terminal 1500 and the user terminal 1510 mutually discover and measure distance and AoA in a multi-host session configuration.

Referring to FIG. 15B, the first host terminal 1500 may initiate the HUS controller session 1520, and the second host terminal 1505 and the user terminal 1510 may initiate the HUS controlee sessions 1525 1527. The HUS controller session 1520 and the HUS controlee session 1525 each may include CBR1, CBR2, and TWR1 phases.

The first host terminal 1500 operates as a controller in the CBR1 phase 1530, and may discover at least one user terminal 1510. In other words, the first host terminal 1500 may collect address information about at least one user terminal 1510. For example, the first host terminal 1500 may transmit a control message to at least one user terminal 1510 and receive the MAC address from the controlees. The second host terminal 1505 operates as a controller in the CBR2 phase 1540, and may discover at least one user terminal 1510. In other words, the second host terminal 1505 may collect address information about the peripheral controlees. The first host terminal 1500 and the user terminal 1510 may perform distance and AoA measurement in the TWR1 phase 1550.

FIGS. 16A, 16B, 16C, and 16D are views illustrating an example of operations of a user terminal in a session configuration in a multi-host case in a UWB payment system according to various embodiments of the disclosure.

The first host terminal (host 1) 1600 and the second host terminal (host 2) 1605 illustrated in FIGS. 16A, 16B, 16C, and 16D may correspond to the first host terminal, the second host terminal, and the user terminal illustrated in FIGS. 14A, 14B, 14C, 15A, and 15B.

Referring to FIG. 16A, in the UWB payment system according to an embodiment, the first host terminal 1600, the second host terminal 1605, and the user terminal 1610 mutually discover and measure distance and AoA in a multi-host session configuration.

As illustrated in FIG. 11, when the user terminal 1661 is discovered in the CBR1 phase or the CBR2 phase, the first host terminal 1600, the second host terminal 1605, or the user terminal 1610 may output a ranging report upon termination of the CBR1 phase or the CBR2 phase.

In an embodiment, the user terminal 1610 may execute a timer for initiating a TWR2 session when outputting the ranging report in the CBR1 phase or the CBR2 phase.

In an embodiment, the timer may be set to a time Ts to the inter-session space (ISS) after the HUS session ends, from the time when the ranging report is output. When the timer expires, the user terminal 1610 may start the TWR 2 session simultaneously and perform mutual distance measurement.

In this case, the timer T for starting the TWR2 session may be set with respect to the ranging report output time of the first host terminal 1600 or the ranging report output time of the second host terminal 1605.

Referring to FIGS. 16B, 16C, and 16D, the first host terminal 1600 may initiate a HUS controller session and TWR2 session 1620, and the second host terminal 1605 and the user terminal 1610 may initiate HUS controlee sessions 1630 1640. The HUS controller session and the HUS controlee session each may include CBR1, CBR2, and TWR1 phases.

FIG. 16B illustrates a case in which a timer T of the timer starting a TWR2 session is set with respect to a ranging report output time point in the CBR1 phase triggered by the first host terminal 1600.

Referring to FIG. 16B, the first host terminal 1600 may discover the user terminal 1610 in the CBR1 phase 1650 and output a ranging report 1655 at the end of the CBR1 phase 1650. In an embodiment, the timer T 1657 of the timer starting the TWR2 session may be set to T=2A+2B+C (ms) with respect to the time when the ranging report 1655 is output. In other words, the user terminal 1610 may initiate the TWR2 session, a time of Tms after the time when the ranging report 1655 is output. As described in connection with FIGS. 10A, 12A, 12B, and 12C may refer to phase and session length (Ams), inter-phase space (IPS) (Bms), and inter-session space (ISS) (Cms).

Referring to FIG. 16C, the second host terminal 1605 may discover the user terminal 1610 in the CBR2 phase 1660 and output a ranging report 1665 at the end of the CBR2 phase 1660. In an embodiment, time T 1667 of the timer for starting the TWR2 session may be set to T=A+B+C (ms) with respect to the time when the ranging report 1655 is output. In other words, the user terminal 1610 may initiate the TWR2 session, a time of Tms after the time when the ranging report 1665 is output. As described in connection with FIGS. 10A, 12A, 12B, and 12C may refer to phase and session length (Ams), inter-phase space (IPS) (Bms), and inter-session space (ISS) (Cms).

Referring to FIG. 16C, the user terminal 1610 may initiate a TWR2 session 1670 at the time when the predetermined timer T expires. The second host terminal 1605 and the user terminal 1610 may measure a distance or transmit and receive data in the TWR2 session 1675. As the first host terminal 1600, the second host terminal 1605, and the user terminal 1610 simultaneously start the TWR2 sessions, the session may be stably driven.

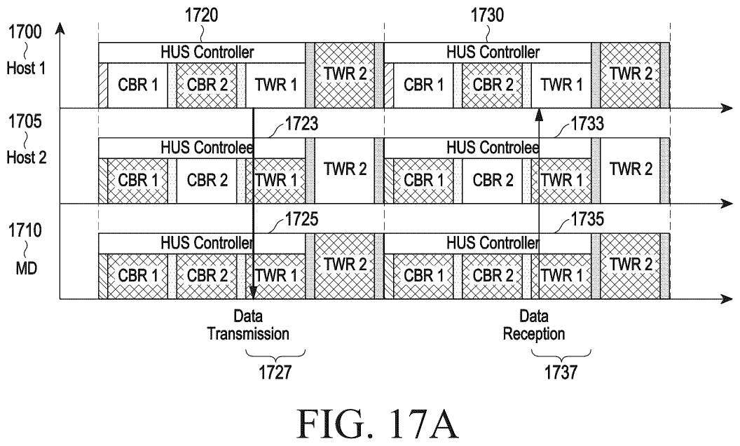

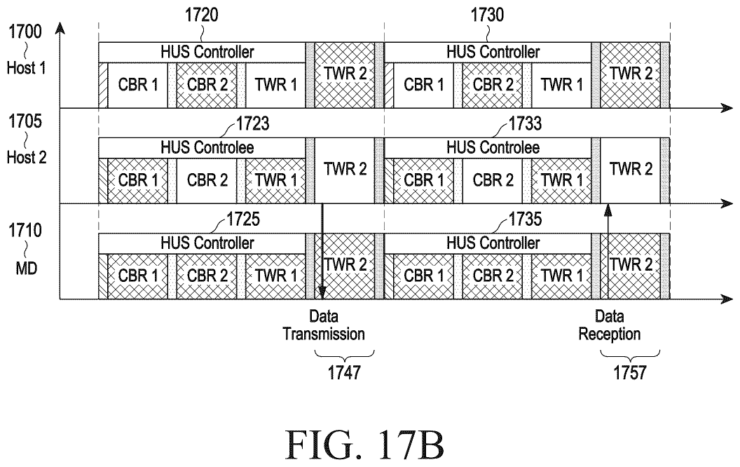

FIGS. 17A and 17B are views illustrating a data transmission/reception operation between a host terminal and a user terminal in a session configuration in a multi-host case in a UWB payment system according to various embodiments of the disclosure.

The UWB payment system illustrated in FIGS. 17A and 17B may include a first host terminal (Host 1) 1700, a second host terminal (Host 2) 1705, and a user terminal (MD) 1710. FIGS. 17A and 17B illustrate data transmission/reception operations after the first host terminal (Host 1) 1700, the second host terminal (Host 2) 1705, and the user terminal (MD) 1710 complete time synchronization between the host terminal and the user terminal as described in connection with FIGS. 10A, 10B, 11, 12A to 12C, 14A to 14C, 15A, 15B, and 16A to 16D.

FIG. 17A is a view illustrating a data transmission/reception operation between a first host terminal and a user terminal in a session configuration in a multi-host case in a UWB payment system according to an embodiment of the disclosure.

Referring to FIG. 17A, the first host terminal 1700 may initiate the HUS controller session and the TWR 2 session 1720, and the second host terminal 1705 and the user terminal 1710 may initiate the HUS controlee session and the TWR 2 sessions 1723 and 1725. The HUS controller session and the HUS controlee session may include CBR1, CBR2, and TWR1 phases. The first host terminal 1700 may transmit data to the user terminal 1710 in a piggyback scheme in the TWR1 phase (1727).

In the next cycle, the first host terminal 1700 may initiate the HUS controller session and the TWR 2 session 1730, and the second host terminal 1705 and the user terminal 1710 may initiate the HUS controlee session and the TWR 2 sessions 1733 and 1735. The user terminal 1710 may transmit data to the first host terminal 1700 in the TWR1 phase (1737).

FIG. 17B is a view illustrating a data transmission/reception operation between a second host terminal and a user terminal in a session configuration in a multi-host case in a UWB payment system according to an embodiment of the disclosure.

Referring to FIG. 17B, the first host terminal 1700 may initiate the HUS controller session and the TWR 2 session 1720, and the second host terminal 1705 and the user terminal 1710 may initiate the HUS controlee session and the TWR 2 sessions 1723 and 1725. The HUS controller session and the HUS controlee session may include CBR1, CBR2, and TWR1 phases. The second host terminal 1705 may transmit data to the user terminal 1710 in a piggyback scheme in the TWR2 phase (1747).

In the next cycle, the first host terminal 1700 may initiate the HUS controller session and the TWR 2 session 1730, and the second host terminal 1705 and the user terminal 1710 may initiate the HUS controlee session and the TWR 2 sessions 1733 and 1735. The user terminal 1710 may transmit data to the second host terminal 1705 in the TWR2 phase (1757).

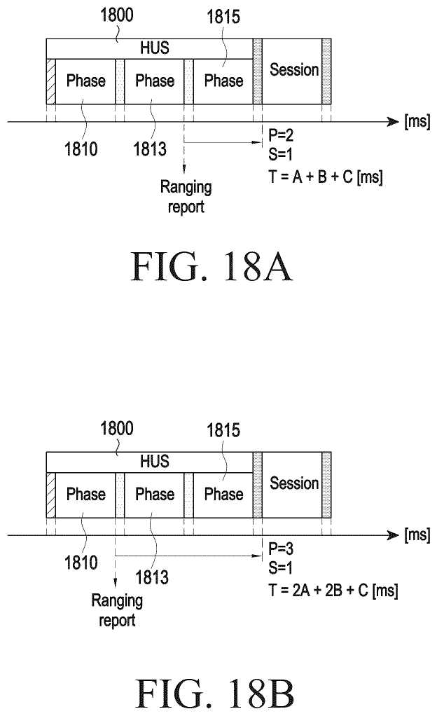

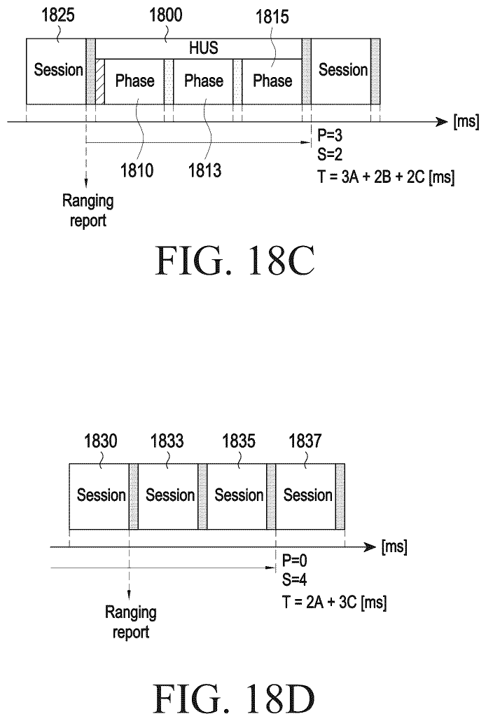

FIGS. 18A and 18B are views illustrating a timer setting operation in a session configuration in a multi-host case in a UWB payment system according to various embodiments of the disclosure.

FIGS. 18A and 18B are view illustrating an example of a method of setting the time T of the timer described in connection with FIGS. 12A, 12B, 12C, 16B, 16C, and 16D.

In an embodiment, the time T of the timer may be determined by Equation 1 below.

$$T = \{ \begin{matrix}( P + S - 2 ) * A + ( P - 1 ) * B + S * C , & if P > 0 \\ ( P + S - 2 ) * A + ( S - 1 ) * C , & if P = 0\end{matrix} \} \qquad Equation 1$$

A: length of session (or phase),
B: length of inter-phase space (IPS)
C: length of inter-session space (ISS)
P: number of phases
S: number of sessions

In an embodiment, P and S may determine the numbers of phases and sessions from a session (or phase) in which a ranging report is output to a session start time.

For example, in the case of FIG. 18A, the number of phases 1813 and 1815 that may be counted as P is 2, and the number of sessions 1800 that may be counted as S is 1, and the following calculation may be made: T=(2+1−2)*A+(2−1)*B+1*C=A+B+C (ms).

For example, in the case of FIG. 18B, the number of phases 1810, 1813, and 1815 that may be counted as P is 3, and the number of sessions 1800 that may be counted as S is 1, and the following calculation may be made: T=(3+1−2)*A+(3−1)*B+1*C=2A+2B+C (ms).

For example, in the case of FIG. 18C, the number of phases 1810, 1813, and 1815 that may be counted as P is 3, and the number of sessions 1800 and 1825 that may be counted as S is 2, and the following calculation may be made: T=(3+2−2)*A+(3−1)*B+2*C=3A+2B+2C (ms).

For example, in the case of FIG. 18D, the number of phases that may be counted as P is 0, and the number of sessions 1830, 1833, 1835, and 1837 that may be counted as S is 4, and the following calculation may be made: T=(4−2)*A+(4−1)*C=2A+3C (ms).

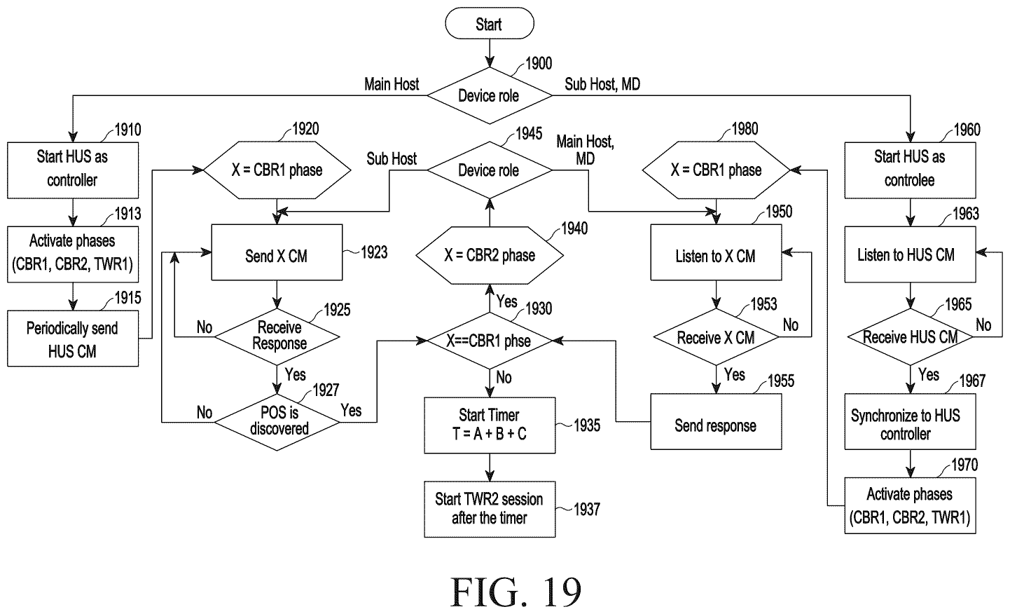

FIG. 19 is a flowchart illustrating a method by an electronic device according to an embodiment of the disclosure.

The electronic device illustrated in FIG. 19 may include a terminal in a payment system using UWB communication described with reference to FIGS. 1 to 5, 6A to 6F, 7A, 7B, 8A, 8B, 9A, 9B, 10A, 10B, 11, 12A to 12C, 13, 14A to 14C, 15A, 15B, 16A to 16D, 17A, 17B, 18A, and 18B. In an embodiment, the electronic device may include a terminal that plays a role as a controller or a controlee in the UWB communication described in connection with FIGS. 1 to 5, 6A to 6F, 7A, 7B, 8A, 8B, 9A, 9B, 10A, 10B, 11, 12A to 12C, 13, 14A to 14C, 15A, 15B, 16A to 16D, 17A, 17B, and 18A to 18D. The electronic device illustrated in FIG. 19 may include a main host terminal serving as a controller, at least one sub host terminal other than the main host terminal, and a user terminal in the payment system using UWB communication described in connection with FIGS. 1 to 5, 6A to 6F, 7A, 7B, 8A, 8B, 9A, 9B, 10A, 10B, 11, 12A to 12C, 13, 14A to 14C, 15A, 15B, 16A to 16D, 17A, 17B, 18A, and 18B.

First, operations when the electronic device is a main host terminal are described.

Referring to FIG. 19, the electronic device may determine whether the role of the device is a main host terminal, a sub host terminal, or a user terminal (mobile device (MD)) in operation 1900. When the role of the device is the main host terminal, the electronic device may initiate the HUS as the controller in operation 1910. In operation 1913, the electronic device may activate phases CBR1, CBR2, and TWR1. In operation 1915, an HUS control message CM may be periodically transmitted. In operation 1920, the electronic device may input CBR1 phase to X. In operation 1923, the electronic device may transmit a control message CM in the CBR1 phase input to X. In operation 1925, the electronic device may determine whether a response has been received. If the electronic device does not receive the response, it may retransmit the control message CM in the CBR1 phase input to X in operation 1923, and may repeat the operation of operation 1923 until a response is received in operation 1925.

Upon receiving a response in operation 1925, the electronic device may determine whether a host terminal (i.e., a POS terminal) has been discovered in operation 1927. When the electronic device does not discover the host terminal, the electronic device may retransmit the control message CM in the CBR1 phase input to X in operation 1923, and, in operation 1927, repeat the operations of operations 1923 and 1925 until the host terminal is discovered.

When the host terminal is discovered in operation 1927, the electronic device may determine whether X is the CBR1 phase in operation 1930.

Since the CBR1 phase has been input to X in operation 1920, the electronic device may determine that X is not the CBR1 phase in operation 1930 and input a CBR2 phase to X in operation 1940. In operation 1945, the electronic device may determine whether the role of the device is a main host terminal, a sub host terminal, or a user terminal (mobile device (MD)). The electronic device is a main host terminal, and may listen to a control message in operation X, i.e., a CBR2 phase (listen). In operation 1953, the electronic device may determine whether a control message is received in X, i.e., the CBR2 phase. When receiving a control message in the CBR2 phase, the electronic device may transmit a response message in operation 1955. The electronic device may determine whether X is the CBR1 phase in operation 1930. Since the CBR2 phase is input as the X value, X is not the CBR1 phase, so that the electronic device may initiate a timer (T=A+B+C) in operation 1935. In operation 1937, the electronic device may initiate a TWR session after the timer expires.

Next, operations when the electronic device is a sub host terminal are described.

Referring to FIG. 19, the electronic device may determine whether the role of the device is a main host terminal, a sub host terminal, or a user terminal (mobile device (MD)) in operation 1900. When the role of the device is a sub host terminal, the electronic device may initiate the HUS as a controlee in operation 1960. In operation 1963, an HUS control message CM may be listened to. In operation 1965, the electronic device may determine whether the HUS control message has been received. When receiving the HUS control message, the electronic device may perform synchronization with the HUS controller in operation 1967. In operation 1970, the electronic device may activate phases CBR1, CBR2, and TWR1.

In operation 1980, the electronic device may input CBR1 phase to X. In operation 1950, the electronic device may listen to a control message in X, i.e., the CBR1 phase. In operation 1953, the electronic device may determine whether a control message is received in X, i.e., the CBR1 phase. When receiving a control message in the CBR1 phase, the electronic device may transmit a response message in operation 1955. The electronic device may determine whether X is the CBR1 phase in operation 1930. Since the CBR1 phase has been input to X, the electronic device may determine that X is not the CBR1 phase in operation 1930 and input a CBR2 phase to X in operation 1940. In operation 1945, the electronic device may determine whether the role of the device is a main host terminal, a sub host terminal, or a user terminal (mobile device (MD)). Since the electronic device is a sub host terminal, in operation 1923, the electronic device may transmit a control message CM in the CBR2 phase input to X. In operation 1925, the electronic device may determine whether a response has been received. If the electronic device does not receive the response, it may retransmit the control message CM in the CBR2 phase input to X in operation 1923, and may repeat the operation of operation 1923 until a response is received in operation 1925.

Upon receiving a response in operation 1925, the electronic device may determine whether a host terminal (i.e., a POS terminal) has been discovered in operation 1927. When the electronic device does not discover the host terminal, the electronic device may retransmit the control message CM in the CBR2 phase input to X in operation 1923, and, in operation 1927, repeat the operations of operations 1923 and 1925 until the host terminal is discovered.

When the host terminal is discovered in operation 1927, the electronic device may determine whether X is the CBR1 phase in operation 1930. Since the CBR2 phase has been input to X in operation 1940, and thus, X is not the CBR1 phase, the electronic device may initiate a timer (T=A+B+C) in operation 1935. In operation 1937, the electronic device may initiate a TWR session after the timer expires.

Next, operations when the electronic device is a user terminal are described.

Referring to FIG. 19, the electronic device may determine whether the role of the device is a main host terminal, a sub host terminal, or a user terminal (mobile device (MD)) in operation 1900. When the role of the electronic device is a user terminal, the electronic device may operate in the same manner as when the electronic device is a sub host terminal from operations 1960 to 1945. Since the electronic device is a user terminal in operation 1945, the electronic device may proceed to operation 1950 and may operate in the same manner as the host terminal as described above from operations 1950 to 1937.

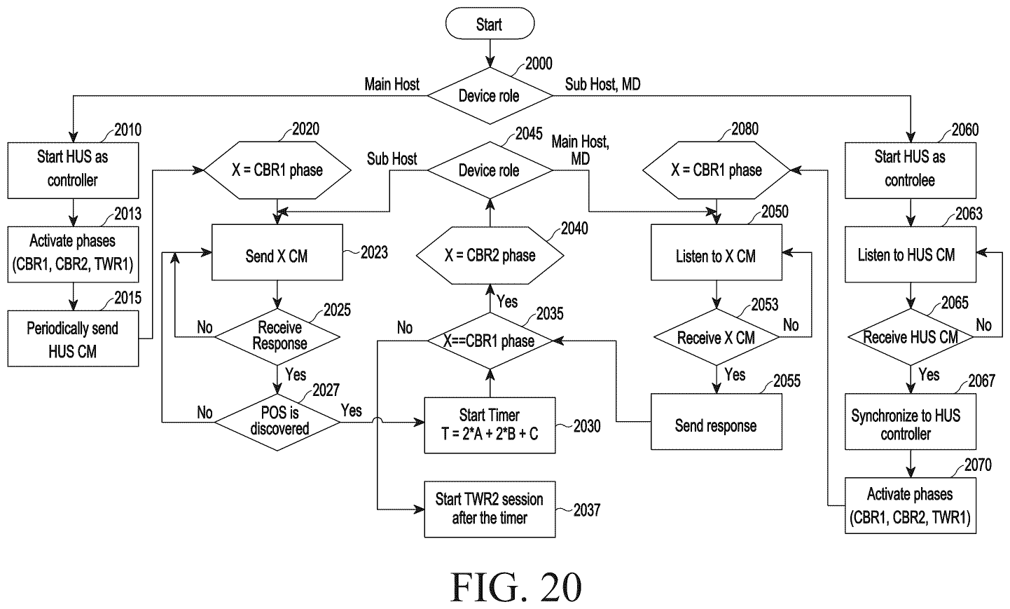

FIG. 20 is a flowchart illustrating a method by an electronic device according to an embodiment of the disclosure.

The electronic device illustrated in FIG. 20 may include a terminal in a payment system using UWB communication described with reference to FIGS. 1 to 5, 6A to 6F, 7A, 7B, 8A, 8B, 9A, 9B, 10A, 10B, 11, 12A to 12C, 13, 14A to 14C, 15A, 15B, 16A to 16D, 17A, 17B, 18A, and 18B. In an embodiment, the electronic device may include a terminal that plays a role as a controller or a controlee in the UWB communication described in connection with FIGS. 1 to 5, 6A to 6F, 7A, 7B, 8A, 8B, 9A, 9B, 10A, 10B, 11, 12A to 12C, 13, 14A to 14C, 15A, 15B, 16A to 16D, 17A, 17B, and 18A to 18D. The electronic device illustrated in FIG. 19 may include operations 2000-2080, a main host terminal serving as a controller, at least one sub host terminal other than the main host terminal, and a user terminal in the payment system using UWB communication described in connection with FIGS. 1 to 5, 6A to 6F, 7A, 7B, 8A, 8B, 9A, 9B, 10A, 10B, 11, 12A to 12C, 13, 14A to 14C, 15A, 15B, 16A to 16D, 17A, 17B, and 18A and 18B.

FIG. 20 differs only in operations 2027 to 2037 in the flowchart of FIG. 19, and those described in connection with FIG. 19 may apply to the other operations.

When the electronic device is a main host terminal, in the state in which the CBR1 phase has been input as the X value, it may be determined whether a pos terminal (i.e., a sub host terminal) is discovered in operation 2027. When the pos terminal (i.e., a sub host terminal) is discovered, the electronic device may initiate the timer (T=2A+2B+C) in operation 2030. Thereafter, in operation 2035, the electronic device may determine whether X is the CBR1 phase. When the electronic device is the main host terminal, the CBR1 phase has been input to X, so that the electronic device may proceed to operation 2040, inputting the CBR2 phase to X and then performing the subsequent operations.

When the electronic device is a sub host terminal, in the state in which the CBR2 phase has been input as the X value, it may be determined whether a pos terminal (i.e., a main host terminal) is discovered in operation 2027. When the pos terminal (i.e., a sub host terminal) is discovered, the electronic device may initiate the timer (T=2A+2B+C) in operation 2030. Thereafter, in operation 2035, the electronic device may determine whether X is the CBR1 phase. When the electronic device is a sub host terminal, since the CBR2 phase has been input as the X value, the electronic device may proceed to operation 2037, initiating a TWR session after the timer expires.

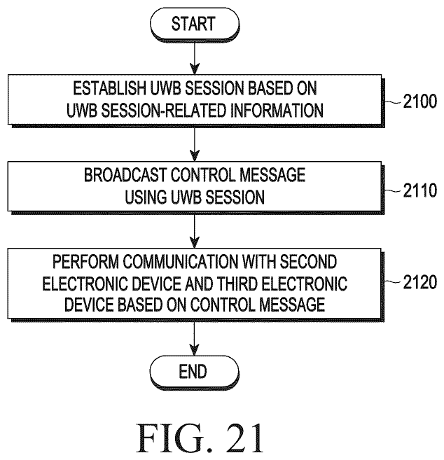

FIG. 21 is a flowchart illustrating operations of a first electronic device according to an embodiment of the disclosure.

The first electronic device illustrated in FIG. 21 may include a main host terminal that transmits an HUS controller session among the host terminals illustrated in FIGS. 1 to 5, 6A to 6F, 7A, 7B, 8A, 8B, 9A, 9B, 10A, 10B, 11, 12A to 12C, 13, 14A to 14C, 15A, 15B, 16A to 16D, 17A, 17B, 18A to 18D, 19, and 20.

In operation 2100, the first electronic device may establish a UWB session based on the UWB session-related information.

In operation 2110, the first electronic device may broadcast a control message using the UWB session.

In operation 2120, the first electronic device may communicate with a second electronic device and a third electronic device based on the control message.

In an embodiment, the UWB session of one ranging interval may include a hybrid UWB (HUS) session including at least one contention-based ranging (CBR) phase and at least one first two-way ranging (TWR) phase, and a second TWR session.

In an embodiment, the first electronic device may perform synchronization with the second electronic device based on the control message. In an embodiment, the first electronic device may transmit and receive data to and from the third electronic device based on the control message. In an embodiment, the HUS session may include a first CBR phase, a second CBR phase, and the first TWR phase.

In an embodiment, the first electronic device may discover at least one of the second electronic device or the third electronic device in the at least one CBR phase. In an embodiment, the first electronic device may transmit a ranging report to at least one of the second electronic device or the third electronic device. In an embodiment, the ranging report may be used to determine a time to initiate a second TWR session of at least one of the second electronic device or the third electronic device.

In an embodiment, the first electronic device may perform distance measurement with the second electronic device in the second TWR phase.

In an embodiment, the first electronic device may transmit and receive data to and from the third electronic device in the first TWR phase.

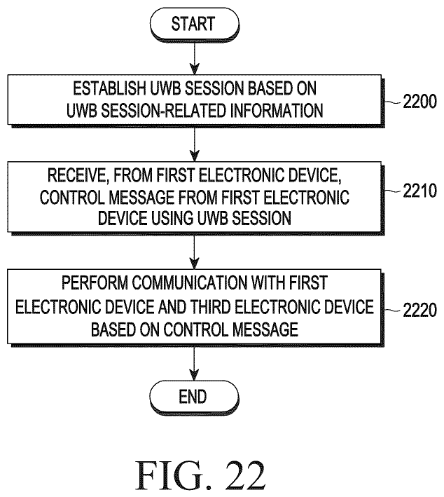

FIG. 22 is a flowchart illustrating operations of a second electronic device according to an embodiment of the disclosure.

The second electronic device illustrated in FIG. 22 may include a sub host terminal that transmits an HUS controlee session among the host terminals illustrated in FIGS. 1 to 5, 6A to 6F, 7A, 7B, 8A, 8B, 9A, 9B, 10A, 10B, 11, 12A to 12C, 13, 14A to 14C, 15A, 15B, 16A to 16D, 17A, 17B, 18A to 18D, 19, and 20.

In operation 2200, the second electronic device may establish the UWB session based on the UWB session-related information.

In operation 2210, the second electronic device may receive a control message from the first electronic device using the UWB session.

In operation 2220, the second electronic device may communicate with the first electronic device and the third electronic device based on the control message.

In an embodiment, the UWB session of one ranging interval may include a hybrid UWB (HUS) session including at least one contention-based ranging (CBR) phase and at least one first two-way ranging (TWR) phase, and a second TWR session.

In an embodiment, the second electronic device may perform synchronization with the first electronic device based on the control message. In an embodiment, the second electronic device may transmit and receive data to and from the third electronic device based on the control message.

In an embodiment, the HUS session may include a first CBR phase, a second CBR phase, and the first TWR phase.

In an embodiment, the second electronic device may discover at least one of the first electronic device or the third electronic device in the at least one CBR phase. In an embodiment, the second electronic device may transmit a ranging report to at least one of the first electronic device and the third electronic device. In an embodiment, the ranging report may be used to determine a time to initiate a second TWR session of at least one of the second electronic device or the third electronic device.

In an embodiment, the second electronic device may perform distance measurement with the first electronic device in the second TWR phase.

In an embodiment, the second electronic device may transmit and receive data to and from the third electronic device in the second TWR phase.

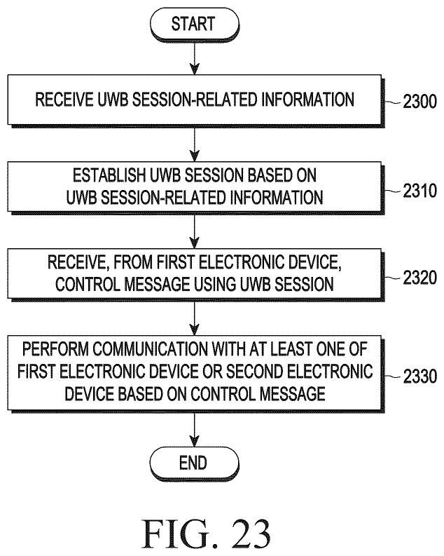

FIG. 23 is a flowchart illustrating operations of a third electronic device according to an embodiment of the disclosure.

The third electronic device illustrated in FIG. 23 may include the user terminal illustrated in FIGS. 1 to 5, 6A to 6F, 7A, 7B, 8A, 8B, 9A, 9B, 10A, 10B, 11, 12A to 12C, 13, 14A to 14C, 15A, 15B, 16A to 16D, 17A, 17B, 18A to 18D, 19, and 20.

In operation 2300, the third electronic device may receive UWB session-related information.

In operation 2310, the third electronic device may establish the UWB session based on the UWB session-related information.

In operation 2320, the third electronic device may receive a control message from the first electronic device using the UWB session.

In operation 2330, the third electronic device may perform communication with at least one of the first electronic device or the second electronic device based on the control message.

As an example, the second electronic device may be synchronized with the first electronic device. In an embodiment, the UWB session of one ranging interval may include a hybrid UWB (HUS) session including at least one contention-based ranging (CBR) phase and at least one first two-way ranging (TWR) phase, and a second TWR session.

In an embodiment, the third electronic device may include an operation of transmitting and receiving data with the first electronic device or the second electronic device based on the control message.

In an embodiment, the HUS session may include a first CBR phase, a second CBR phase, and the first TWR phase.

In an embodiment, the third electronic device may receive a ranging report from the first electronic device. In an embodiment, the third electronic device may determine a time to initiate the second TWR session based on the ranging report. In an embodiment, the third electronic device may initiate the second TWR session at the determined time.

In an embodiment, the third electronic device may transmit and receive data to and from the first electronic device in the first TWR phase. In an embodiment, the third electronic device may transmit and receive data to and from the second electronic device in the second TWR phase.

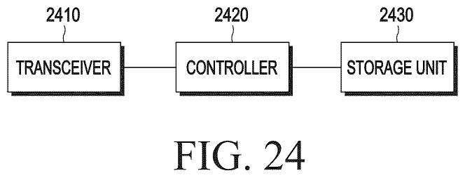

FIG. 24 is a view illustrating a structure of an electronic device according to an embodiment of the disclosure.

The electronic device of FIG. 24 may include the host terminal, the user terminal, the first electronic device, the second electronic device, and the third electronic device described in connection with FIGS. 1 to 5, 6A to 6F, 7A, 7B, 8A, 8B, 9A, 9B, 10A, 10B, 11, 12A to 12C, 13, 14A to 14C, 15A, 15B, 16A to 16D, 17A, 17B, 18A to 18D, 19, 20, 21, 22, and 23.

Referring to FIG. 24, the electronic device may include a transceiver 2410, a controller 2420, and a storage unit 2430. In the disclosure, the controller may be defined as a circuit, an application-specific integrated circuit, or at least one processor.

The transceiver 2410 may transmit and receive signals to/from other network entities. The transceiver 2410 may transmit/receive data to/from another electronic device using, e.g., UWB communication.

The controller 2420 may control the overall operation of the electronic device according to an embodiment. For example, the controller 2420 may control inter-block signal flow to perform the operations according to the above-described flowchart. Specifically, the controller 2420 may control the operations of the electronic device described above with reference to FIGS. 1 to 5, 6A to 6F, 7A, 7B, 8A, 8B, 9A, 9B, 10A, 10B, 11, 12A to 12C, 13, 14A to 14C, 15A, 15B, 16A to 16D, 17A, 17B, 18A to 18D, 19, 20, 21, 22, and 23. The controller 2420 may include at least one processor.

The storage unit 2430 may store at least one of information transmitted/received via the transceiver 2410 and information generated via the controller 2420. For example, the storage unit 2430 may store information and data for payment processing using UWB described above with reference to FIGS. 1 to 5, 6A to 6F, 7A, 7B, 8A, 8B, 9A, 9B, 10A, 10B, 11, 12A to 12C, 13, 14A to 14C, 15A, 15B, 16A to 16D, 17A, 17B, 18A to 18D, 19, 20, 21, 22, and 23.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a first electronic device using ultra-wide band (UWB) communication, the method comprising:
establishing a UWB session based on information related to the UWB session;
broadcasting a control message using the UWB session; and
performing communication with a second electronic device and a third electronic device based on the control message,
wherein the UWB session of a first ranging interval includes a hybrid UWB (HUS) session including at least one contention-based ranging (CBR) phase and at least one first two-way ranging (TWR) phase, and a second TWR session.

2. The method of claim 1, wherein performing the communication with the second electronic device and the third electronic device based on the control message comprises:
performing synchronization with the second electronic device based on the control message; and
transmitting and receiving data with the third electronic device based on the control message.

3. The method of claim 1, wherein the HUS session includes a first CBR phase, a second CBR phase, and the first TWR phase.

4. The method of claim 1, further comprising:
discovering at least one of the second electronic device or the third electronic device in the at least one CBR phase; and
transmitting, to at least one of the second electronic device or the third electronic device, at least one ranging report,
wherein the at least one ranging report is used to determine a time of initiating at least one second TWR session of at least one of the second electronic device or the third electronic device.

5. The method of claim 3, further comprising:
performing distance measurement with the second electronic device in a second TWR phase.

6. The method of claim 3, further comprising:
transmitting and receiving data with the third electronic device in the first TWR phase.

7. A method performed by a second electronic device using ultra-wide band (UWB) communication, the method comprising:
establishing a UWB session based on information related to the UWB session;
receiving, from a first electronic device, a control message using the UWB session; and
performing communication with the first electronic device and a third electronic device based on the control message,
wherein the UWB session of a first ranging interval includes a hybrid UWB (HUS) session including at least one contention-based ranging (CBR) phase and at least one first two-way ranging (TWR) phase, and a second TWR session.

8. The method of claim 7, wherein performing the communication with the first electronic device and the third electronic device based on the control message comprises:
performing synchronization with the first electronic device based on the control message; and
transmitting and receiving data with the third electronic device based on the control message.

9. The method of claim 7, wherein the HUS session includes a first CBR phase, a second CBR phase, and the first TWR phase.

10. The method of claim 7, further comprising:
discovering at least one of the first electronic device or the third electronic device in the at least one CBR phase; and
transmitting, to at least one of the first electronic device or the third electronic device, at least one ranging report,
wherein the at least one ranging report is used to determine a time of initiating at least one second TWR session of at least one of the second electronic device or the third electronic device.

11. The method of claim 9, further comprising:
performing distance measurement with the first electronic device in a second TWR phase.

12. The method of claim 9, further comprising:
transmitting and receiving data with the third electronic device in a second TWR phase.

13. A first electronic device using ultra-wide band (UWB) communication, comprising:
a transceiver; and
one or more processors coupled to the transceiver; and
at least one memory, communicatively coupled to the one or more processors, storing instructions executable by the one or more processors individually or in any combination to cause the first electronic device to:
establish a UWB session based on information related to the UWB session,
broadcast a control message using the UWB session, and
perform communication with a second electronic device and a third electronic device based on the control message, and
wherein the UWB session of a first ranging interval includes a hybrid UWB (HUS) session including at least one contention-based ranging (CBR) phase and at least one first two-way ranging (TWR) phase and a second TWR session.

14. The first electronic device of claim 13, wherein the instructions, when executed by the one or more processors individually or collectively, cause the first electronic device to:
perform synchronization with the second electronic device based on the control message, and
transmit and receive data with the third electronic device based on the control message.

15. The first electronic device of claim 13, wherein the HUS session includes a first CBR phase, a second CBR phase, and the first TWR phase.

16. The first electronic device of claim 13,
wherein the instructions, when executed by the one or more processors individually or collectively, cause the first electronic device to:
discover at least one of the second electronic device or the third electronic device in the at least one CBR phase, and
transmit, to at least one of the second electronic device or the third electronic device, at least one ranging report, and
wherein the at least one ranging report is used to determine a time of initiating at least one second TWR session of at least one of the second electronic device or the third electronic device.

17. A second electronic device using ultra-wide band (UWB) communication, the second electronic device comprising:
a transceiver; and
one or more processors coupled to the transceiver; and
at least one memory, communicatively coupled to the one or more processors, storing instructions executable by the one or more processors individually or in any combination to cause the second electronic device to:
establish a UWB session based on information related to the UWB session,
receive, from a first electronic device, a control message using the UWB session, and
perform communication with the first electronic device and a third electronic device based on the control message,
wherein the UWB session of a first ranging interval includes a hybrid UWB (HUS) session including at least one contention-based ranging (CBR) phase and at least one first two-way ranging (TWR) phase, and a second TWR session.

18. The second electronic device of claim 17,
wherein the instructions, when executed by the one or more processors individually or collectively, cause the second electronic device to:
perform synchronization with the first electronic device based on the control message, and
transmit and receive data with the third electronic device based on the control message.

19. The second electronic device of claim 17, wherein the HUS session includes a first CBR phase, a second CBR phase, and the first TWR phase.

20. The second electronic device of claim 17,
wherein the instructions, when executed by the one or more processors individually or collectively, cause the second electronic device to:
discover least one of the first electronic device or the third electronic device in the at least one CBR phase, and
transmit, to at least one of the first electronic device or the third electronic device, at least one ranging report, and
wherein the at least one ranging report is used to determine a time of initiating at least one second TWR session of at least one of the second electronic device or the third electronic device.
